(19) United States
(12) Patent Application Publication
(10) Pub. No.: US 2026/0242262 A1
(43) Pub. Date: Aug. 20, 2026

(54) VERMIFILTER SYSTEMS AND METHODS FOR WASTEWATER FILTRATION

(71) Applicant: TBF-Solutions Inc., Oakland, CA (US)

(72) Inventors: Roger SATHRE, Tbilisi (GE); Ajeet OAK, Pune (IN); Payan OLE-MOIYOI, Kilifi (KE)

(73) Assignee: TBF-Solutions Inc., Oakland, CA (US)

(21) Appl. No.: 19/542,573

(22) Filed: Feb. 17, 2026

Related U.S. Application Data
(60) Provisional application No. 63/760,001, filed on Feb. 18, 2025.

(51) Int. Cl. C02F 3/04; C02F 3/32; C02F 103/00

(52) U.S. Cl. CPC C02F 3/04; C02F 3/327; C02F 2103/002; C02F 2103/005; C02F 2201/002; C02F 2301/04; C02F 2301/06

(57) ABSTRACT

Provided herein are filtration systems for treating wastewater (e.g., greywater and/or blackwater). The wastewater filtration system can include, one or more inlet pipes, a first container comprising one or more vermifilters, a second container comprising one or more vermifilters and one or more plant species, a filter system and/or one or more outlet pipes. More particularly, the wastewater filtration system provided herein includes a macro-organism and/or microorganisms for primary and secondary treatment of wastewater. In some embodiments, the macro-organism comprises Eisenia fetida. In some embodiments, the macro-organism comprises a plant species. In some embodiments, the microorganism comprises a bacteria species.

### CROSS-REFERENCE TO RELATED APPLICATIONS

This application claims priority to U.S. Provisional Patent Application No. 63/760,001 filed on Feb. 18, 2025, entitled “VERMIFILTER SYSTEMS AND METHODS FOR WASTEWATER FILTRATION,” the contents of which are incorporated by reference in their entirety.

### FIELD

The present disclosure relates to a filtration system for treating household wastewater safely and completely. In addition, this disclosure relates to a wastewater filtration system for reducing organic waste in blackwater and greywater. More particularly, this disclosure relates to a wastewater filtration system for reducing organic waste in blackwater and greywater using a macro-organism and/or microorganism.

### BACKGROUND

Residential, commercial, agricultural, and industrial water usage generates wastewater that, when left untreated, can present health hazards to humans and wildlife. For example, residential areas that rely on cesspools for the temporary storage of untreated wastewater have a heightened risk for contamination of drinking water sources including groundwater and streams. In regions where drinking water sources are already limited (e.g., islands or desert regions), contamination of existing drinking water sources can have long-term, detrimental consequences.

Current alternatives to cesspools include septic tanks. However, the installation and maintenance of septic tanks long-term can be cost prohibitive. In addition, septic tanks may not be able to be installed in certain environments.

### SUMMARY

Provided herein are systems that can include a macro-organism and/or plant species for reducing organic waste in household wastewater, thereby providing affordable, alternative wastewater treatment systems to residential areas. The wastewater filtration systems and methods provided herein can clean household wastewater to a purity level acceptable by the National Sanitation Foundation (NSF) at a limited cost, allowing treated wastewater to be released back into the environment without risk of contamination.

In some aspects, provided herein is a filtration system for treating wastewater, the system comprising: one or more inlet pipes configured to transfer wastewater to the filtration system; a first container fluidically connected to the one or more inlet pipes and configured to receive the wastewater from the one or more inlet pipes, wherein the first container comprises one or more first vermifilters configured to treat the wastewater to form a primary treated wastewater; a second container fluidically connected to the first container and configured to receive the primary treated wastewater from the first container, wherein the second container comprises one or more second vermifilters and one or more plant species and the one or more second vermifilters and/or one or more plant species are configured to treat the primary treated wastewater to form a secondary treated wastewater; and one or more outlet pipes fluidically connected to the second container and configured to transfer the secondary treated wastewater out of the filtration system, wherein a portion of the first container is within the second container. In some embodiments, the first container is detachable from the second container. In some embodiments, a side of the first container is flush with a side of the second container.

In some embodiments, the wastewater flows through the wastewater filtration system on a gravity gradient. In some embodiments, the wastewater flows into the first container to undergo a primary treatment and the primary treated wastewater flows into the second container to undergo a secondary treatment.

In some embodiments, the wastewater flows from the one or more inlet pipes into the first container to undergo the primary treatment; the primary treated wastewater flows from the first container into the second container to undergo the secondary treatment; and the secondary treated wastewater flows from the second container into the one or more outlet pipes. In some embodiments, the primary and secondary treatment reduce the amount of solid material in the wastewater. In some embodiments, the primary and secondary treatment reduce the amount of suspended solids in the wastewater.

In some embodiments, the secondary treated wastewater has an average biochemical oxygen demand (BOD) measurement of <25 mg/L. In some embodiments, the secondary treated wastewater has an average total suspended solid (TSS) measurement of <30 mg/L.

In some embodiments, the one or more inlet pipes transfer wastewater from a wastewater source to the first container. In some embodiments, the one or more inlet pipes are operably and/or fluidically connected to a side of the first container near the top of the first container. In some embodiments, the one or more inlet pipes do not come into contact with the second container.

In some embodiments, the one or more inlet pipes transfer greywater and/or blackwater to the first container. In some embodiments, the one or more inlet pipes transfer greywater and blackwater to the first container.

In some embodiments, the wastewater filtration system comprises one inlet pipe. In some embodiments, the wastewater filtration system comprises two inlet pipes. In some embodiments, the two inlet pipes include a first inlet pipe and a second inlet pipe. In some embodiments, the first inlet pipe and the second inlet pipe are parallel to each other. In some embodiments, the first inlet pipe has a larger diameter than the second inlet pipe.

In some embodiments, the first or second inlet pipe transfers greywater to the first container and the other of the first or second inlet pipe transfers blackwater to the first container. In some embodiments, the first inlet pipe transfers blackwater to the first container and the second inlet pipe transfers greywater to the first container.

In some embodiments, the one or more outlet pipes is operably and/or fluidically connected to a side of the second container. In some embodiments, the one or more outlet pipes is operably and/or fluidically connected to an internal and external side of the second container. In some embodiments, the one or more outlet pipes is located near the top of the second container. In some embodiments, the one or more outlet pipes does not come into contact with the first container.

In some embodiments, the one or more outlet pipes collect secondary treated wastewater and transfers it to a disposal site. In some embodiments, the one or more outlet pipes comprises an access point to allow for sampling and testing of the treated wastewater. In some embodiments, the one or more outlet pipes comprises one or more pipes operably and/or fluidically connected with a pipe tee fitting. In some embodiments, the one or more outlet pipes comprises a first, second and third pipe operably and/or fluidically connected with a pipe tee fitting. In some embodiments, the first and second pipes are perpendicular to the third pipe.

In some embodiments, the first and second pipes are perforated to collect the treated wastewater. In some embodiments, the first and second pipes transfer the secondary treated wastewater to the third pipe. In some embodiments, the third pipe transports the secondary treated wastewater to a disposal site.

In some embodiments, the first container has one or more dimensions that is less than one or more dimensions of the second container. In some embodiments, the first container has a length that is less than the length of the second container. In some embodiments, the first container has a width that is less than the width of the second container. In some embodiments, the first container has one or more dimensions that is greater than one or more dimensions of the second container. In some embodiments, the first container has a height that is greater than the height of the second container.

In some embodiments, the first container comprises one or more access hatches situated on top of the first container. In some embodiments, the one or more access hatches are detachable from the first container. In some embodiments, the one or more access hatches are connected to the first container via a hinge.

In some embodiments, the first container is a multi-chamber container. In some embodiments, the first container comprises a top chamber and a bottom chamber. In some embodiments, the top chamber is separated from the bottom chamber by a grate. In some embodiments, the grate is porous. In some embodiments, the bottom chamber can be accessed from the top chamber via a tube. In some embodiments, the bottom chamber is a sedimentation basin. In some embodiments, the bottom chamber comprises one or more holes to allow the primary treated wastewater to flow into the second container.

In some embodiments, the top chamber is subdivided into a first chamber and a second chamber. In some embodiments, the first chamber and the second chamber are subdivided by a wall. In some embodiments, the one or more vermifilters in the first container are housed in the top, single chamber. In some embodiments, the one or more vermifilters in the first container are housed in the top, first and second chambers.

In some embodiments, the one or more vermifilters comprise a biomedia providing a habitat for a worm species. In some embodiments, the biomedia comprises rock, gravel, cinder (e.g., volcanic rock or lava rock), soil, coir, compost, wood chip, bark chip or any combination thereof. In some embodiments, the biomedia is lava rock. In some embodiments, the biomedia is fine to coarse in size. In some embodiments, the biomedia is medium to coarse in size.

In some embodiments, the worm species digests solid materials in the wastewater. In some embodiments, the worm species belongs to the genus Eisenia. In some embodiments, the worm species is Eisenia fetida or Eisenia andreii. In some embodiments, the one or more plant species comprise a wetland or hydrophytic plant species. In some embodiments, the one or more plant species is not Cyperus papyrus.

In some aspects, provided herein is a filtration system for treating wastewater, the system comprising: a first inlet pipe configured to transfer greywater to the filtration system and a second inlet pipe configured to transfer blackwater to the filtration system (b) a first container fluidically connected to the first and second inlet pipes and configured to receive the greywater and the blackwater from the first and second inlet pipes, wherein the first container comprises a first vermifilter configured to treat the greywater and a second vermifilter configured to treat the blackwater, wherein the treated greywater and treated blackwater are combined in the first container to form a primary treated wastewater; a second container fluidically connected to the first container and configured to receive the primary treated wastewater from the first container, wherein the second container comprises a third vermifilter and one or more plant species configured to treat the primary treated wastewater to form a secondary treated wastewater; and an outlet pipe fluidically connected to the second container and configured to transfer the secondary treated wastewater out of the filtration system, wherein a portion of the first container is within the second container. In some embodiments, the first and second vermifilters comprise a biomedia and a worm species. In some embodiments, the first, second and third vermifilters comprise a biomedia, a worm species and a bacteria species. In some embodiments, the one or more plant species comprise a wetland or hydrophytic plant species.

In some aspects, provided herein is a filtration system for treating wastewater, the system comprising: (a) one or more inlet pipes configured to transfer wastewater to the filtration system; (b) a container fluidically connected to the one or more inlet pipes and configured to receive the wastewater from the one or more inlet pipes, wherein the container comprises one or more vermifilters configured to treat the wastewater; and (c) one or more outlet pipes fluidically connected to the container and configured to transfer the treated wastewater out of the filtration system.

In some embodiments, the container comprises: (i) a grate comprising the one or more vermifilters configured to treat the wastewater to form a primary treated wastewater, wherein the grate is fluidically connected to the one or more inlet pipes; (ii) a sump tank configured to receive the primary treated wastewater; and (iii) a pump configured to pump the primary treated wastewater to a filter system, wherein the filter system is configured to treat the primary treated wastewater to form a secondary treated wastewater, wherein the one or more outlet pipes are configured to transfer the secondary treated wastewater out of the filtration system.

In some aspects, provided herein is a filtration system for treating wastewater, the system comprising: (a) one or more inlet pipes configured to transfer wastewater to the filtration system; (b) a container fluidically connected to the one or more inlet pipes and configured to receive the wastewater from the one or more inlet pipes, wherein the container comprises: (i) a grate comprising one or more vermifilters configured to treat the wastewater to form a primary treated wastewater; (ii) a sump tank configured to receive the primary treated wastewater; and (iii) a pump configured to pump the primary treated wastewater to a filter system, wherein the filter system is configured to treat the primary treated wastewater to form a secondary treated wastewater; and (c) one or more outlet pipes fluidically connected to the container and configured to transfer the secondary treated wastewater out of the filtration system.

In some embodiments, the one or more inlet pipes transfer greywater and/or blackwater to the container. In some embodiments, the filtration system comprises one inlet pipe. In some embodiments, the filtration system comprises one outlet pipe.

In some embodiments, the grate is stair-step shaped and comprises two or more, three or more, four or more, five or more, or six or more stair-steps. In some embodiments, each stair-step of the stair-step shaped grate is permeable. In some embodiments, the one or more vermifilters are located on each stair-step of the stair-step shaped grate. In some embodiments, the one or more vermifilters comprise a biomedia, a bacteria species and/or a worm species. In some embodiments, the one or more vermifilters comprises a biomedia, a bacteria species and a worm species.

In some embodiments, the filter system comprises a feed pipe, a water distribution system, and a filter tank. In some embodiments, the feed pipe is operably and/or fluidically connected to the pump, the water distribution system, and the filter tank. In some embodiments, the water distribution system comprises one or more sprinklers. In some embodiments, the filter tank is permeable. In some embodiments, the filter tank comprises a biomedia. In some embodiments, the filter tank comprises a bacteria species and/or a worm species. In some embodiments, the filter tank comprises a bacteria species. In some embodiments, the filter tank comprises a bacteria species and a worm species. In some embodiments, the biomedia provides a habitat for the worm species.

In some embodiments, the biomedia comprises rock, cinder (e.g., volcanic rock or lava rock), gravel, soil, coir, compost, wood chip, bark chip, plastic, or any combination thereof. In some embodiments, the biomedia is coir. In some embodiments, the biomedia is fine to coarse in size. In some embodiments, the biomedia is medium to coarse in size.

In some embodiments, the worm species digests solid materials in the wastewater. In some embodiments, the worm species belongs to the genus Eisenia. In some embodiments, the worm species is Eisenia fetida or Eisenia andreii.

In some embodiments, (a) the wastewater flows from the one or more inlet pipes into the container to undergo one or more, two or more, three or more, four or more, five or more or six or more treatments; and (b) the treated wastewater flows from the container into the one or more outlet pipes.

In some embodiments, the wastewater flows through the filtration system on a gravity gradient and/or a pressure gradient. In some embodiments, the wastewater flows through the filtration system on a gravity gradient and a pressure gradient.

In some embodiments, the wastewater flows from the one or more inlet pipes into the container to the grate; the wastewater flows from the grate to the sump tank via a gravity gradient, the wastewater undergoing a primary treatment; the primary treated wastewater flows from the sump tank to the filter system via a pressure gradient, the primary treated wastewater undergoing a secondary treatment; and the secondary treated wastewater flows from the filter tank to the sump tank via a gravity gradient, the secondary treated wastewater flowing from the sump tank to the one or more outlet pipes.

In some embodiments, the wastewater flows from the one or more inlet pipes into the container to the grate; the wastewater flows from the grate to the sump tank via a gravity gradient, the wastewater undergoing a primary treatment; the primary treated wastewater flows from the sump tank to the filter system via a pressure gradient, the primary treated wastewater undergoing a secondary treatment; the secondary treated wastewater flows from the filter tank to the sump tank via a gravity gradient; and the secondary treated wastewater flows from the sump tank to the filter system via the pump and feed pipe two or more, three or more, four or more, five or more or six or more times prior to flowing to the one or more outlet pipes.

In some embodiments, the filter system is a trickling filter system. In some embodiments, the filter system is an aerated trickling filter system.

Additional advantages will be readily apparent to those skilled in the art from the following detailed description. The examples and descriptions herein are to be regarded as illustrative in nature and not restrictive.

### BRIEF DESCRIPTION OF THE DRAWINGS

Exemplary embodiments are described with reference to the accompanying figures, in which:

FIG. 1 illustrates an external, three-dimensional view of a wastewater filtration system in accordance with some embodiments provided herein.

FIG. 2 illustrates an internal, top view of a wastewater filtration system in accordance with some embodiments provided herein.

FIG. 3 illustrates an internal, front view of a wastewater filtration system in accordance with some embodiments provided herein.

FIG. 4 illustrates an internal, side view of the wastewater filtration system in accordance with some embodiments provided herein.

FIG. 5A illustrates biological oxygen demand (BOD; mg/L) in treated blackwater samples collected from a filtration system disclosed herein across 12 months.

FIG. 5B illustrates biological oxygen demand (BOD; mg/L) in treated greywater samples collected from a filtration system disclosed herein across 12 months.

FIG. 5C illustrates the weighted average of BOD calculated based on 10% blackwater and 90% greywater samples collected from a filtration system disclosed herein across 12 months.

FIG. 6A illustrates total suspended solids (TSS; mg/L) in treated blackwater samples collected from a filtration system disclosed herein across 12 months.

FIG. 6B illustrates total suspended solids (TSS; mg/L) in treated greywater samples collected from a filtration system disclosed herein across 12 months.

FIG. 6C illustrates the weighted average of TSS calculated based on 10% blackwater and 90% greywater samples collected from a filtration system disclosed herein across 12 months.

FIG. 7A illustrates a three-dimensional, internal view of a wastewater filtration system in accordance with some embodiments provided herein.

FIG. 7B illustrates a three-dimensional, internal view of a wastewater filtration system in accordance with some embodiments provided herein.

FIG. 7C illustrates a two-dimensional, internal view of a wastewater filtration system in accordance with some embodiments provided herein.

FIG. 7D illustrates a two-dimensional, internal view of a wastewater filtration system in accordance with some embodiments provided herein. The dashed line depicts the water level of the wastewater.

FIG. 7E illustrates a two-dimensional, internal top view of a wastewater filtration system in accordance with some embodiments provided herein.

FIG. 7F illustrates a three-dimensional, external view of a wastewater filtration system in accordance with some embodiments provided herein, with dimensions shown in inches.

FIG. 8A illustrates a two-dimensional, internal view of a wastewater filtration system in accordance with some embodiments provided herein.

FIG. 8B illustrates a two-dimensional, internal side view of a wastewater filtration system in accordance with some embodiments provided herein.

FIG. 8C illustrates a three-dimensional, internal view of a wastewater filtration system in accordance with some embodiments provided herein.

FIG. 9A illustrates a two-dimensional, internal view of an aerated trickling filter system provided herein.

FIG. 9B illustrates a three-dimensional, internal view of an aerated trickling filter system provided herein.

FIG. 9C illustrates a three-dimensional, internal view of biomedia contained in an aerated trickling filter in accordance with some embodiments provided herein.

FIG. 9D is a photograph depicting a three-dimensional, internal top view of an aerated trickling filter in accordance with some embodiments provided herein.

FIG. 9E is a photograph depicting a water distribution system in accordance with some embodiments provided herein.

FIG. 9F is a photograph depicting the wastewater flowing through a water distribution system provided herein and depicted in FIG. 9D and FIG. 9E.

FIG. 10A is a photograph depicting a stair-step shaped structure containing vermifilters in accordance with some embodiments provided herein.

FIG. 10B is a photograph depicting wastewater flowing through the stair-step shaped structure containing vermifilters in accordance with some embodiments provided herein and depicted in FIG. 10A.

### DETAILED DESCRIPTION

Provided herein is a wastewater filtration system that can treat various sources of wastewater including residential, commercial, industrial and agricultural wastewater sources.

Several global communities face water shortages. As of 2022, approximately half of the world's population experienced severe water scarcity for at least part of the year, while one quarter of the world's population experienced high levels of water stress, defined as using over 80% of their annual renewable freshwater supply (The United Nations World Water Development Report 2024: Water for prosperity and peace). Further, an estimated 80% of municipal and industrial wastewater is discharged into the environment without any prior treatment (Lin et al., Frontiers in environmental science, 2022, 10:880246). In residential areas that rely on cesspools, untreated wastewater can often leak into the ground, contaminating drinking water sources. Thus, it is becoming increasingly important to find cost-effective and sustainable solutions to treat wastewater in water scarce regions.

The present disclosure provides cost-effective systems for treating wastewater by providing one or more vermifilters that can treat household wastewater such as blackwater and/or greywater. Vermifiltration, a wastewater treatment process, can be a superior form of sanitation compared to cesspools and septic tanks. In some embodiments, vermifiltration also offers a sustainable alternative to cesspools and septic tanks, which emit greenhouse gases such as methane and carbon dioxide. Vermifilters can include a biomedia suitable for providing a habitat for a worm species (e.g., an earthworm species) and/or other macro-organisms (e.g., a plant species) and microorganisms. Earthworms and/or microorganisms can consume and digest organic waste, thereby treating wastewater. The biomedia can further treat wastewater by trapping undigested solids and other sediment.

### I. Definitions

Before describing the invention in detail, it is to be understood that the terminology used herein is for the purpose of describing particular embodiments only, and is not intended to be limiting.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a” “an” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes” “including” “comprises” and/or “comprising” when used herein, specify the presence of stated features, integers, steps, operations, elements, components, and/or units but do not preclude the presence or addition of one or more other features, integers, steps, operations, elements, components, units, and/or groups thereof.

Throughout this disclosure, various aspects are presented in a range format. It should be understood that the description in range format is merely for convenience and brevity and should not be construed as an inflexible limitation on the disclosure. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed in the disclosure. The upper and lower limits of these smaller ranges may independently be included in the smaller ranges, and are also encompassed in the disclosure, subject to any specifically excluded limit in the stated range. Where the stated range includes one or both of the limits, ranges excluding either or both of those included limits are also included in the disclosure. This applies regardless of the breadth of the range.

The term “about” as used herein refers to the usual error range for the respective value readily known. Reference to “about” a value or parameter herein includes (and describes) embodiments that are directed to that value or parameter per se. For example, description referring to “about X” includes description of “X”. In some embodiments, “about” may refer to ±25%, ±20%, ±15%, ±10%, ±5%, or ±1% as understood by a person of skill in the art.

### II. Wastewater Filtration System

Provided herein is a filtration system for treating wastewater. In some embodiments, the wastewater filtration system provided herein comprises one or more components. In some embodiments, the one or more components include one or more pipes and/or one or more containers. In some embodiments, the wastewater filtration system comprises a biomedia and one or more living organisms. In some embodiments, the one or more living organisms include macro-organisms and/or microorganisms. In some embodiments, the one or more macro-organisms comprise a worm species and/or a plant species. In some embodiments, the one or more microorganisms comprise one or more bacteria species. In some embodiments, the containers of the wastewater filtration system comprise the biomedia, one or more worm species and/or plant species, and/or one or more bacteria species.

Water treatment can be a process that eliminates and/or reduces the level of contaminants in water. In some embodiments, wastewater contains at least one contaminant including organic and/or inorganic contaminants. Organic and inorganic contaminants can include, without limitation, feces, urine, blood, toilet tissue, chlorine-based toilet cleaners, detergents, human and animal medications, pesticides or herbicides, nitrates, phosphates, industrial chemicals, volatile organic compounds, microplastics, and/or heavy metals (e.g., lead, mercury, arsenic).

In some embodiments, the wastewater filtration system provided herein can eliminate and/or reduce the amount of any of the contaminants (e.g., organic and/or inorganic materials) disclosed herein. In some embodiments, the process of eliminating and/or reducing contaminants in wastewater is referred to as treating the wastewater. In some embodiments, the wastewater filtration system can eliminate and/or reduce the amount or levels of solid material in wastewater.

The amount or levels of solid material in wastewater can be determined by various methods known in the art. In some embodiments, the amount or levels of solid material in wastewater can be determined by assessing biochemical oxygen demand (BOD), which indicates the amount of dissolved oxygen consumed by bacteria while decomposing solid material. A high BOD (measured in mg/L) can signify a greater amount of organic matter and thus a higher level of pollution. In some embodiments, wastewater treated by the filtration system provided herein has a BOD of about 5 mg/L to about 50 mg/L. In some embodiments, wastewater treated by the filtration system provided herein has a BOD of about 50 mg/L, about 49 mg/L, about 48 mg/L, about 47 mg/L, about 46 mg/L, about 45 mg/L, about 44 mg/L, about 43 mg/L, about 42 mg/L, about 41 mg/L, about 40 mg/L, about 39 mg/L, about 38 mg/L, about 37 mg/L, about 36 mg/L, about 35 mg/L, about 34 mg/L, about 33 mg/L, about 32 mg/L, about 31 mg/L, about 30 mg/L, about 29 mg/L, about 28 mg/L, about 27 mg/L, about 26 mg/L, about 25 mg/L, about 24 mg/L, about 23 mg/L, about 22 mg/L, about 21 mg/L, about 20 mg/L, about 19 mg/L, about 18 mg/L, about 17 mg/L, about 16 mg/L, about 15 mg/L, about 14 mg/L, about 13 mg/L, about 12 mg/L, about 11 mg/L, or about 10 mg/L. In some embodiments, wastewater treated by the filtration system provided herein has a BOD of less than about 50 mg/L. In some embodiments, wastewater treated by the filtration system provided herein has a BOD of less than about 50 mg/L, less than about 49 mg/L, less than about 48 mg/L, less than about 47 mg/L, less than about 46 mg/L, less than about 45 mg/L, less than about 44 mg/L, less than about 43 mg/L, less than about 42 mg/L, less than about 41 mg/L, less than about 40 mg/L, less than about 39 mg/L, less than about 38 mg/L, less than about 37 mg/L, less than about 36 mg/L, less than about 35 mg/L, less than about 34 mg/L, less than about 33 mg/L, less than about 32 mg/L, less than about 31 mg/L, less than about 30 mg/L, less than about 29 mg/L, less than about 28 mg/L, less than about 27 mg/L, less than about 26 mg/L, less than about 25 mg/L, less than about 24 mg/L, less than about 23 mg/L, less than about 22 mg/L, less than about 21 mg/L, less than about 20 mg/L, less than about 19 mg/L, less than about 18 mg/L, less than about 17 mg/L, less than about 16 mg/L, less than about 15 mg/L, less than about 14 mg/L, less than about 13 mg/L, less than about 12 mg/L, less than about 11 mg/L, or less than about 10 mg/L. In some embodiments, wastewater treated by the filtration system provided herein has a BOD of less than about 25 mg/L.

The amount or levels of solid material in wastewater can also be determined by assessing total suspended solids (TSS), which refers to the measure of the total amount of solid particles in a water sample. The solid particles could be sediment or organic matter that are not dissolved or filtered. The total solid material present in the water can contribute to the oxygen demand by bacteria in a BOD test. In some embodiments, wastewater treated by the filtration system provided herein has a TSS of about 5 mg/L to about 50 mg/L. In some embodiments, wastewater treated by the filtration system provided herein has a TSS of about 50 mg/L, about 49 mg/L, about 48 mg/L, about 47 mg/L, about 46 mg/L, about 45 mg/L, about 44 mg/L, about 43 mg/L, about 42 mg/L, about 41 mg/L, about 40 mg/L, about 39 mg/L, about 38 mg/L, about 37 mg/L, about 36 mg/L, about 35 mg/L, about 34 mg/L, about 33 mg/L, about 32 mg/L, about 31 mg/L, about 30 mg/L, about 29 mg/L, about 28 mg/L, about 27 mg/L, about 26 mg/L, about 25 mg/L, about 24 mg/L, about 23 mg/L, about 22 mg/L, about 21 mg/L, about 20 mg/L, about 19 mg/L, about 18 mg/L, about 17 mg/L, about 16 mg/L, about 15 mg/L, about 14 mg/L, about 13 mg/L, about 12 mg/L, about 11 mg/L, or about 10 mg/L. In some embodiments, wastewater treated by the filtration system provided herein has a TSS of less than about 50 mg/L. In some embodiments, wastewater treated by the filtration system provided herein has a TSS of less than about 50 mg/L, less than about 49 mg/L, less than about 48 mg/L, less than about 47 mg/L, less than about 46 mg/L, less than about 45 mg/L, less than about 44 mg/L, less than about 43 mg/L, less than about 42 mg/L, less than about 41 mg/L, less than about 40 mg/L, less than about 39 mg/L, less than about 38 mg/L, less than about 37 mg/L, less than about 36 mg/L, less than about 35 mg/L, less than about 34 mg/L, less than about 33 mg/L, less than about 32 mg/L, less than about 31 mg/L, less than about 30 mg/L, less than about 29 mg/L, less than about 28 mg/L, less than about 27 mg/L, less than about 26 mg/L, less than about 25 mg/L, less than about 24 mg/L, less than about 23 mg/L, less than about 22 mg/L, less than about 21 mg/L, less than about 20 mg/L, less than about 19 mg/L, less than about 18 mg/L, less than about 17 mg/L, less than about 16 mg/L, less than about 15 mg/L, less than about 14 mg/L, less than about 13 mg/L, less than about 12 mg/L, less than about 11 mg/L, or less than about 10 mg/L. In some embodiments, wastewater treated by the filtration system provided herein has a BOD of less than about 30 mg/L.

In some embodiments, the filtration system can treat the wastewater one or more times (e.g., a primary, secondary, tertiary and/or quaternary treatment). In some embodiments, the filtration system treats the wastewater one, two, three, four, five or more times. In some embodiments, the wastewater can be treated one time. In some embodiments, the wastewater can be treated two times. In some embodiments, the wastewater is treated three times. In some embodiments, the wastewater is treated four times. In some embodiments, the wastewater is treated five times. In some embodiments, the wastewater is treated six times.

In some embodiments, the wastewater filtration system can treat several hundred or thousand gallons of wastewater per day. In some embodiments, the wastewater filtration system can treat up to 1000 gallons per day (gal/day). In some embodiments, the wastewater filtration system can treat at least 100 gal/day, at least 200 gal/day, at least 300 gal/day, at least 400 gal/day, at least 500 gal/day, at least 600 gal/day, at least 700 gal/day, at least 800 gal/day, at least 900 gal/day or at least 1000 gal/day. In some embodiments, the wastewater filtration system can treat at least 600 gal/day. In some embodiments, the wastewater filtration system can treat more than 1000 gal/day, without limitation. In some embodiments, the wastewater filtration system can treat at least 5000 gal/day, at least 10,000 gal/day, at least 15,000 gal/day, at least 20,000 gal/day or at least 30,000 gal/day.

The filtration system provided herein can treat wastewater from various sources. In some embodiments, the wastewater can be derived from residential, municipal, commercial, agricultural and/or industrial sources. In some embodiments, when the filtration system is used to filter wastewater from residential sources, the wastewater filtration system can be installed underneath the residence. In some embodiments, the wastewater filtration system can be installed a certain distance away from the residence. A wastewater filtration system that treats wastewater from residential sources can be found in IN 494621, which is herein incorporated by reference in its entirety

The filtration system provided herein can treat different types of wastewater. In some embodiments, the wastewater is greywater. Greywater can include any water that is devoid of feces and urine. In some embodiments, greywater includes, without limitation, water from the shower, sink, washing machine, and dishwater. In some embodiments, the wastewater is blackwater. Blackwater can include any water that contains feces and urine. In some embodiments, blackwater includes, without limitation, water from the toilet. Thus, the wastewater filtration system can treat greywater and/or blackwater. In some embodiments, the wastewater filtration system treats greywater. In some embodiments, the wastewater filtration system treats blackwater. In some embodiments, the wastewater filtration system treats greywater and blackwater.

In some embodiments, the greywater and blackwater can be combined or mixed together prior to treatment. That is, in some embodiments, the greywater and blackwater are treated together. In some embodiments, the greywater and blackwater are separately treated. In some embodiments, after an initial separate treatment of the greywater and blackwater, the primary treated greywater and blackwater are combined for a secondary treatment.

In some embodiments, the wastewater filtration system provided herein can have any dimensions suitable for treating wastewater. In some embodiments, the dimensions of the wastewater filtration system can be determined by a skilled artisan based on the amount of wastewater to be treated. In some embodiments, the length, width and/or height of the wastewater filtration system are the same or equal. In some embodiments, the wastewater filtration system can have a length that is equal to its width. In some embodiments, the wastewater filtration system can have a length that is equal to its height. In some embodiments, the wastewater filtration system can have a width that is equal to its height. In some embodiments, the wastewater filtration system can have a length that is equal to its width and height. In some embodiments, the wastewater filtration system can have a width that is equal to its length and height. In some embodiments, the wastewater filtration system can have a height that is equal to its length and width. In some embodiments, the length, width and/or height of the wastewater filtration system are different. In some embodiments, the wastewater filtration system can have a length that is different than its width. In some embodiments, the wastewater filtration system can have a length that is different than its height. In some embodiments, the wastewater filtration system can have a width that is different than its height. In some embodiments, the wastewater filtration system can have a length that is greater than its width and height. In some embodiments, the wastewater filtration system can have a width that is greater than its length and height. In some embodiments, the wastewater filtration system can have a height that is greater than its length and width.

In some embodiments, the wastewater filtration system is from about 1 foot to about 100 feet in length. In some embodiments, the wastewater filtration system is between about 1 foot and about 10 feet in length, about 5 feet and about 15 feet in length, about 10 feet and about 20 feet in length, about 15 feet and about 25 feet in length, about 20 feet and about 30 feet in length, about 25 feet and about 35 feet in length, about 30 feet and about 40 feet in length, about 35 feet and about 45 feet in length, about 40 feet and about 50 feet in length, about 45 feet and about 55 feet in length, about 50 feet and about 60 feet in length, about 55 feet and about 65 feet in length, about 60 feet and about 70 feet, about 65 feet and about 75 feet, about 70 feet and about 80 feet, about 75 feet and about 85 feet, about 80 feet and about 90 feet, about 85 feet and about 95 feet, about 90 feet and about 100 feet in length. In some embodiments, the wastewater filtration system is about 1 foot, about 2 feet, about 3 feet, about 4 feet, about 5 feet, about 6 feet, about 7 feet, about 8 feet, about 9, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, about 30 feet, about 31 feet, about 32 feet, about 33 feet, about 34 feet, about 35 feet, about 36 feet, about 37 feet, about 38 feet, about 39 feet, about 40 feet, about 41 feet, about 42 feet, about 43 feet, about 44 feet, about 45 feet, about 46 feet, about 47 feet, about 48 feet, about 49 feet, about 50 feet, about 51 feet, about 52 feet, about 53 feet, about 54 feet, about 55 feet, about 56 feet, about 57 feet, about 58 feet, about 59 feet, about 61 feet, about 62 feet, about 63 feet, about 64 feet, about 65 feet, about 66 feet, about 67 feet, about 68 feet, about 69 feet, about 70 feet, about 71 feet, about 72 feet, about 73 feet, about 74 feet, about 75 feet, about 76 feet, about 77 feet, about 78 feet, about 79 feet, about 80 feet, about 81 feet, about 82 feet, about 83 feet, about 84 feet, about 85 feet, about 86 feet, about 87 feet, about 88 feet, about 89 feet, about 90 feet, about 91 feet, about 92 feet, about 93 feet, about 94 feet, about 95 feet, about 96 feet, about 97 feet, about 98 feet, about 99 feet or about 100 feet in length.

In some embodiments, the wastewater filtration system is between about 10 feet and 20 feet in length. In some embodiments, the wastewater filtration system is about 16, about 16.1, about 16.2, about 16.3, about 16.4, about 16.5, about 16.6, about 16.7, about 16.8, about 16.9 or about 17 feet in length. In some embodiments, the wastewater filtration system is about 16.6 feet in length.

In some embodiments, the wastewater filtration system is from about 1 foot to about 100 feet in width. In some embodiments, the wastewater filtration system is between about 1 foot and about 10 feet in width, about 5 feet and about 15 feet in width, about 10 feet and about 20 feet in width, about 15 feet and about 25 feet in width, about 20 feet and about 30 feet in width, about 25 feet and about 35 feet in width, about 30 feet and about 40 feet in width, about 35 feet and about 45 feet in width, about 40 feet and about 50 feet in width, about 45 feet and about 55 feet in width, about 50 feet and about 60 feet in width, about 55 feet and about 65 feet in width, about 60 feet and about 70 feet, about 65 feet and about 75 feet, about 70 feet and about 80 feet, about 75 feet and about 85 feet, about 80 feet and about 90 feet, about 85 feet and about 95 feet, about 90 feet and about 100 feet in width. In some embodiments, the wastewater filtration system is about 1 foot, about 2 feet, about 3 feet, about 4 feet, about 5 feet, about 6 feet, about 7 feet, about 8 feet, about 9, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, about 30 feet, about 31 feet, about 32 feet, about 33 feet, about 34 feet, about 35 feet, about 36 feet, about 37 feet, about 38 feet, about 39 feet, about 40 feet, about 41 feet, about 42 feet, about 43 feet, about 44 feet, about 45 feet, about 46 feet, about 47 feet, about 48 feet, about 49 feet, about 50 feet, about 51 feet, about 52 feet, about 53 feet, about 54 feet, about 55 feet, about 56 feet, about 57 feet, about 58 feet, about 59 feet, about 61 feet, about 62 feet, about 63 feet, about 64 feet, about 65 feet, about 66 feet, about 67 feet, about 68 feet, about 69 feet, about 70 feet, about 71 feet, about 72 feet, about 73 feet, about 74 feet, about 75 feet, about 76 feet, about 77 feet, about 78 feet, about 79 feet, about 80 feet, about 81 feet, about 82 feet, about 83 feet, about 84 feet, about 85 feet, about 86 feet, about 87 feet, about 88 feet, about 89 feet, about 90 feet, about 91 feet, about 92 feet, about 93 feet, about 94 feet, about 95 feet, about 96 feet, about 97 feet, about 98 feet, about 99 feet or about 100 feet in width.

In some embodiments, the wastewater filtration system is between about 5 feet and 10 feet in width. In some embodiments, the wastewater filtration system is about 5.5, about 5.6, about 5.7, about 5.8, about 5.9, about 6, about 6.1, about 6.2, about 6.3, about 6.4, about 6.5, about 6.6, about 6.7, about 6.8, about 6.9 or about 7 feet in width.

In some embodiments, the wastewater filtration system is from about 1 foot to about 100 feet in height. In some embodiments, the wastewater filtration system is between about 1 foot and about 10 feet in height, about 5 feet and about 15 feet in height, about 10 feet and about 20 feet in height, about 15 feet and about 25 feet in height, about 20 feet and about 30 feet in height, about 25 feet and about 35 feet in height, about 30 feet and about 40 feet in height, about 35 feet and about 45 feet in height, about 40 feet and about 50 feet in height, about 45 feet and about 55 feet in height, about 50 feet and about 60 feet in height, about 55 feet and about 65 feet in height, about 60 feet and about 70 feet, about 65 feet and about 75 feet, about 70 feet and about 80 feet, about 75 feet and about 85 feet, about 80 feet and about 90 feet, about 85 feet and about 95 feet, about 90 feet and about 100 feet in height. In some embodiments, the wastewater filtration system is about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, about 30 feet, about 31 feet, about 32 feet, about 33 feet, about 34 feet, about 35 feet, about 36 feet, about 37 feet, about 38 feet, about 39 feet, about 40 feet, about 41 feet, about 42 feet, about 43 feet, about 44 feet, about 45 feet, about 46 feet, about 47 feet, about 48 feet, about 49 feet, about 50 feet, about 61 feet, about 62 feet, about 63 feet, about 64 feet, about 65 feet, about 66 feet, about 67 feet, about 68 feet, about 69 feet, about 70 feet, about 71 feet, about 72 feet, about 73 feet, about 74 feet, about 75 feet, about 76 feet, about 77 feet, about 78 feet, about 79 feet, about 80 feet, about 81 feet, about 82 feet, about 83 feet, about 84 feet, about 85 feet, about 86 feet, about 87 feet, about 88 feet, about 89 feet, about 90 feet, about 91 feet, about 92 feet, about 93 feet, about 94 feet, about 95 feet, about 96 feet, about 97 feet, about 98 feet, about 99 feet or about 100 feet in height. In some embodiments, the wastewater filtration system is between about 1 feet and 10 feet in height. In some embodiments, the wastewater filtration system is about 1 foot, about 2 feet, about 3 feet, about 4 feet, about 5 feet, about 6 feet, about 7 feet, about 8 feet, about 9 feet or about 10 feet in height.

In some embodiments, the wastewater filtration system can have a dimension (length×width×height) of 16.6 feet×6.2 feet×4 feet.

A person skilled in the art would understand that the wastewater filtration system can be assembled in any configuration that permits the flow of wastewater through the system. In some embodiments, the wastewater flows through the wastewater filtration system along a gravity gradient. In some embodiments, the wastewater flows through the wastewater filtration system along a pressure gradient. In some embodiments, the wastewater flows through the wastewater filtration system due to an applied flow or along a pressure gradient. In some embodiments, the wastewater flows from the one or more inlet pipes to the first container, from the first container to the second container, and from the second container to the one or more outlet pipes. In some embodiments, the wastewater flows from the one or more inlet pipes into the first container to undergo primary treatment. In some embodiments, the primary treated wastewater flows from the first container into the second container to undergo secondary treatment. In some embodiments, the secondary treated wastewater flows from the second container into the one or more outlet pipes.

In some embodiments, the wastewater filtration system comprises: one or more inlet pipes; a first container; a second container; and one or more outlet pipes. In some embodiments, the one or more inlet pipes, first container, second container, and one or more outlet pipes are operably and/or fluidically connected. In some embodiments, the wastewater filtration system is configured to transfer or deliver wastewater from the one or more inlet pipes to the one or more outlet pipes. In some embodiments, the one or more inlet pipes are positioned at a level that is above or superior to the one or more outlet pipes, such that the flow of water through the wastewater filtration system is on a gravity gradient. In some embodiments, the one or more inlet pipes are configured to transfer or deliver wastewater to the filtration system. In some embodiments, the first container is configured to receive wastewater (e.g., greywater and/or blackwater) from the one or more inlet pipes. In some embodiments, the second container is configured to receive primary treated wastewater from the first container. In some embodiments, the first container and second container have different dimensions. In some embodiments, the first container is smaller (i.e., has smaller dimensions) than the second container. In some embodiments, the first container and second container can filter the same volume of wastewater. In some embodiments, the first and second container can filter different volumes of wastewater. In some embodiments, the volume of wastewater filtered by the first container is less than the volume of wastewater filtered by the second container. In some embodiments, the one or more outlet pipes are configured to receive secondary treated wastewater. In some embodiments, the one or more outlet pipes are configured to transfer secondary treated wastewater out of the filtration system to a disposal site.

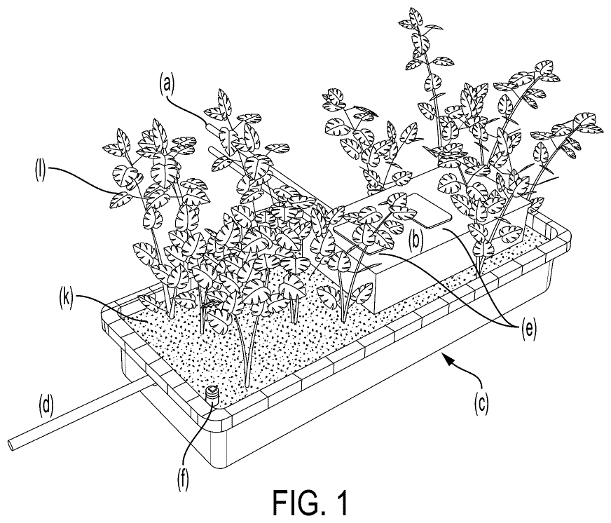

In some embodiments, the wastewater filtration system is externally configured as depicted in FIG. 1. With reference to FIG. 1, in some embodiments, one or more inlet pipes (a), one or more containers ((b) and (c)), and one or more outlet pipes (d) are fluidically and/or operably connected to form the wastewater filtration system. In some embodiments, the one or more containers comprise a second container (c) that can be configured to be partially above ground and partially below ground. In some embodiments, the second container is a plant bed. In some embodiments, the one or more containers comprise a first container (b) that is fluidically and/or operably connected to the second container. In some embodiments, the wastewater filtration system further comprises one or more vermifilters comprising a biomedia (k), one or more macro-organisms (e.g., a worm species and/or a plant species (1)), and/or one or more microorganisms (e.g., bacteria and/or fungi). In some embodiments, the first and second containers comprise the one or more vermifilters. In some embodiments, the wastewater filtration system further comprises one or more access hatches (e) and an access point (f).

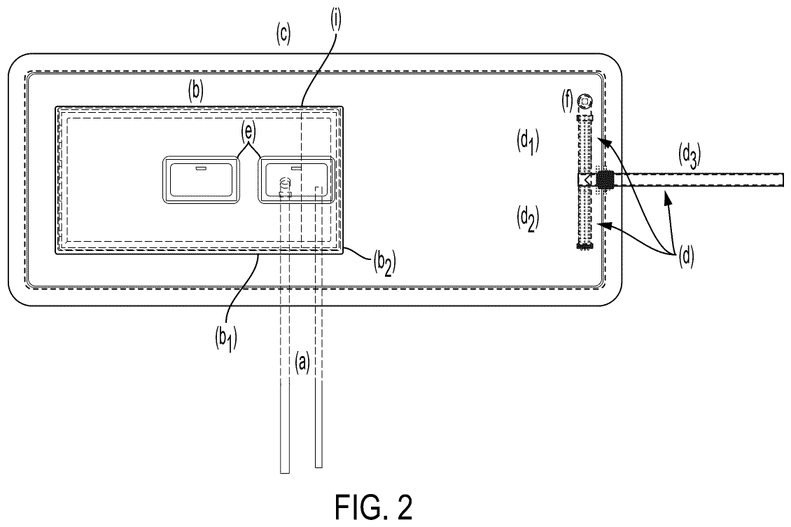

In some embodiments, the wastewater filtration system can be a wastewater filtration system as depicted in FIG. 2. FIG. 2 illustrates a system for filtering or treating wastewater. As shown in FIG. 2, the wastewater filtration system can comprise one or more inlet pipes (a); a first container (b) that is a multi-chamber container comprising a first chamber (b₁) and a second chamber (b₂); a second container (c); and one or more outlet pipes (d) comprising a first (d₁), second (d₂) or third pipe (d₃); one or more access hatches (e); an access point (f); and/or a wall (i) subdividing the first chamber (b₁) and the second chamber (b₂). The one or more inlet pipes (a), the first container (b), the second container (c), and/or the one or more outlet pipes (d) can be operably and/or fluidically connected. In some embodiments, the one or more inlet pipes (a) can be operably and/or fluidically connected to any region of the first container. In some embodiments, the one or more inlet pipes (a) can be fluidically connected to the front, back, sides, top or bottom of the first container (b). In some embodiments, the one or more inlet pipes (a) can be operably and/or fluidically connected to the right, front side of the first container (b) near the top of the first container (b). In some embodiments, the first container (b) comprises a vermifilter. In some embodiments, the second container (c) comprises a vermifilter. In some embodiments, the vermifilter comprises a biomedia, a macro-organism and/or a microorganism. In some embodiments, the macro-organism comprises one or more worm species and/or one or more plant species. In some embodiments, the microorganism comprises one or more species of bacteria.

In some embodiments, the design of the wastewater filtration system in FIG. 2 allows wastewater to flow through the filtration system on a gravity gradient. With reference to FIG. 2, in some embodiments, the one or more inlet pipes (a) transfer greywater and/or blackwater to the first container (b) to initiate the filtration process. In some embodiments, the greywater and blackwater transferred to the filtration system accumulate in the first container (b) where the greywater and blackwater undergo treatment. In some embodiments, the greywater and blackwater in the first container do not mix because of the presence of the wall (i). In some embodiments, the blackwater is transferred to the first chamber (b₁). In some embodiments, the greywater is transferred to the second chamber (b₂). In some embodiments, the greywater and blackwater are treated due to the presence of the vermifilter in the first chamber (b₁) and second chamber (b₂). In some embodiments, the worm species treat the wastewater by consuming and digesting solid materials in the greywater and blackwater. In some embodiments, the biomedia treats the wastewater by trapping solid materials within the biomedia and allowing the treated water to flow through the first container. In some embodiments, the bacteria species treat the wastewater by consuming and digesting solid materials in the greywater and blackwater. In some embodiments, the one or more access hatches (e) allow for the monitoring and/or removal of undigested and/or unfiltered debris. In some embodiments, the one or more access hatches (e) allow for maintenance or upkeep of the one or more vermifilters. In some embodiments, the greywater and blackwater treated in the first chamber (b₁) and second chamber (b₂), flow through the remainder of the first container (b) as primary treated wastewater. In some embodiments, the primary treated wastewater flows into the second container (c). In some embodiments, the primary treated wastewater is filtered in the second container (c) by the same mechanism of action as the in the first container (b) to form secondary treated wastewater. That is, in some embodiments, the worm species treat the wastewater by consuming and digesting solid materials, the biomedia treats the wastewater by trapping solid materials within the biomedia and allowing the treated water to flow through the second container, and the bacteria species treat the wastewater by consuming and digesting solid materials in the greywater and blackwater. In some embodiments, the second container (c) further comprises one or more plant species. In some embodiments, the one or more plant species treat the primary treated wastewater by absorbing contaminants. In some embodiments, the secondary treated wastewater flows from the second container (c) to the first (d₁), second (d₂) and third (d₃) pipes of the one or more outlet pipes (d). In some embodiments, the secondary treated wastewater is sampled via the access point (f) to test contaminant levels.

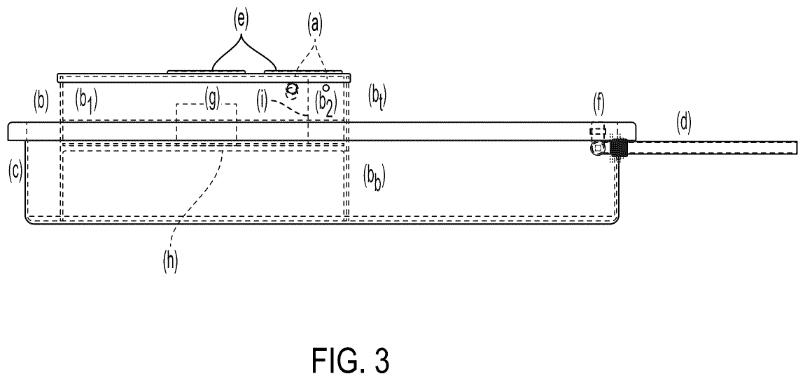

In some embodiments, the wastewater filtration system can be a wastewater filtration system as depicted in FIG. 3. FIG. 3 illustrates another view of the system provided herein for filtering or treating wastewater. As shown in FIG. 3, the wastewater filtration system can comprise one or more inlet pipes (a); a first container (b) that is a multi-chamber container comprising a top chamber (bₜ) subdivided into a first chamber (b₁) and a second chamber (b₂), and bottom chamber (b_{b}), wherein the top (bₜ) chamber is separated from the bottom chamber (b_{b}) by a grate (h); a second container (c); one or more outlet pipes (d); one or more access hatches (e); an access point (f); a tube (g) that originates in the top chamber (bₜ) and allows access to the bottom chamber (b_{b}), a grate (h), and/or a wall (i) subdividing the first chamber (b₁) and the second chamber (b₂). The one or more inlet pipes (a), the first container (b), the second container (c), and/or the one or more outlet pipes (d) can be operably and/or fluidically connected. In some embodiments, the one or more inlet pipes (a) can be operably and/or fluidically connected to any region of the first container (b). In some embodiments, the one or more inlet pipes (a) can be fluidically connected to the front, back, sides, top or bottom of the first container (b). In some embodiments, the one or more inlet pipes (a) can be operably and/or fluidically connected to the right, front side of the first container (b) near the top of the first container. In some embodiments, the first container (b) comprises a vermifilter in the first chamber (b₁) and the second chamber (b₂). In some embodiments, the second container (c) comprises a vermifilter. In some embodiments, the vermifilter comprises a biomedia, a macro-organism and/or a microorganism. In some embodiments, the macro-organism comprises one or more worm species and/or one or more plant species. In some embodiments, the microorganism comprises one or more species of bacteria.

In some embodiments, the design of the wastewater filtration system in FIG. 3 allows wastewater to flow through the filtration system on a gravity gradient. With reference to FIG. 3, in some embodiments, the one or more inlet pipes (a) transfer greywater and/or blackwater to the first container (b) to initiate the filtration process. In some embodiments, the greywater and blackwater transferred to the filtration system accumulate in the first container (b) where the greywater and blackwater undergo treatment. In some embodiments, the greywater and blackwater in the first container do not mix because of the presence of the wall (i). In some embodiments, the blackwater is transferred to the first chamber (b₁). In some embodiments, the greywater is transferred to the second chamber (b₂). In some embodiments, the greywater and blackwater are treated, to form primary treated wastewater, due to the presence of the vermifilter in the first chamber (b₁) and second chamber (b₂). In some embodiments, the worm species treat the wastewater by consuming and digesting solid materials in the greywater and blackwater. In some embodiments, the biomedia treats the wastewater by trapping solid materials within the biomedia and allowing the treated water to flow through the first container. In some embodiments, the bacteria species treat the wastewater by consuming and digesting solid materials in the greywater and blackwater. In some embodiments, the one or more access hatches (e) allow for the monitoring and/or removal of undigested and/or unfiltered debris. In some embodiments, the one or more access hatches (e) allow for maintenance or upkeep of the one or more vermifilters. In some embodiments, the treated greywater and blackwater in the first chamber (b₁) and second chamber (b₂) of the top chamber (bₜ) of the first container, flow into the bottom chamber (b_{b}) of the first container. In some embodiments, the bottom chamber (b_{b}) acts as a sedimentation basin, collecting undigested solids, vermicompost (i.e., product of the worm species, such as earthworm, digestion) and other sediments. In some embodiments, the tube (g) allows for the removal of undigested solids, vermicompost (i.e., product of the worm species, such as earthworm, digestion), and other sediments from the bottom chamber (bₜ). In some embodiments, the primary treated wastewater flows into the second container (c). In some embodiments, the primary treated wastewater flows into the second container (c) due to the presence of one or more holes located on the side of the bottom chamber (b_{b}) of the first container. In some embodiments, the primary treated wastewater is filtered in the second container (c), to form secondary treated wastewater, by the same mechanism of action as the in the first container (b) to form secondary treated wastewater. That is, in some embodiments, the worm species treat the wastewater by consuming and digesting solid materials, the biomedia treats the wastewater by trapping solid materials within the biomedia and allowing the treated water to flow through the second container, and the bacteria species treat the wastewater by consuming and digesting solid materials in the greywater and blackwater. In some embodiments, the second container (c) further comprises one or more plant species. In some embodiments, the one or more plant species treat the primary treated wastewater by absorbing contaminants. In some embodiments, the secondary treated wastewater flows from the second container (c) to the first (d₁), second (d₂) and third (d₃) pipes of the one or more outlet pipes (d). In some embodiments, the secondary treated wastewater is sampled via the access point (f) to test contaminant levels.

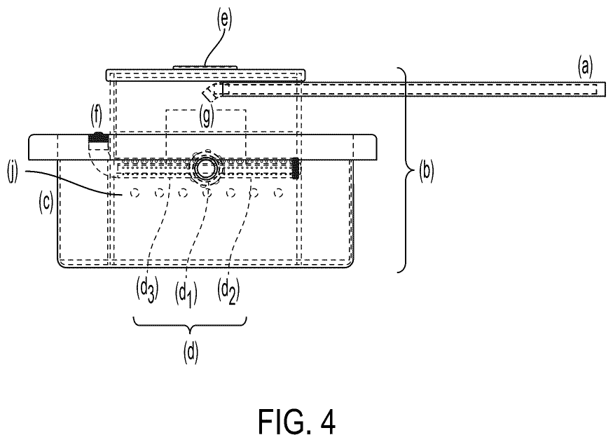

In some embodiments, the wastewater filtration system can be a wastewater filtration system as depicted in FIG. 4. FIG. 4 illustrates another view of the system provided herein for filtering or treating wastewater. As shown in FIG. 4, the wastewater filtration system can comprise one or more inlet pipes (a); a first container (b); a second container (c); and one or more outlet pipes (d) comprising a first (d₁), second (d₂) and third (d₃) pipe; one or more access hatches (e); an access point (f); a tube (g); and/or one or more holes (j) on the side of the second container (b). The one or more inlet pipes (a), the first container (b), the second container (c), and/or the one or more outlet pipes (d) can be operably and/or fluidically connected. In some embodiments, the one or more inlet pipes (a) can be operably and/or fluidically connected to any region of the first container (b). In some embodiments, the one or more inlet pipes (a) can be fluidically connected to the front, back, sides, top or bottom of the first container (b). In some embodiments, the one or more inlet pipes (a) can be operably and/or fluidically connected to the right, front side of the first container (b) near the top of the first container. In some embodiments, the first container (b) comprises one or more vermifilters. In some embodiments, the second container (c) comprises a vermifilter. In some embodiments, the vermifilter comprises a biomedia, a macro-organism and/or a microorganism. In some embodiments, the macro-organism comprises one or more worm species and/or one or more plant species. In some embodiments, the microorganism comprises one or more species of bacteria. In some embodiments, the first container further comprises a tube (g) that originates in the top chamber (bₜ) and allows access to the bottom chamber (b_{b}).

In some embodiments, the design of the wastewater filtration system in FIG. 4 allows wastewater to flow through the filtration system on a gravity gradient. With reference to FIG. 4, the one or more inlet pipes (a) transfer greywater and/or blackwater to the first container (b) to initiate the filtration process. In some embodiments, the greywater and blackwater transferred to the filtration system accumulate in the first container (b) where the greywater and blackwater undergo treatment. In some embodiments, the greywater and blackwater are treated, to form primary treated wastewater, due to the presence of the one or more vermifilters in the first container (b). In some embodiments, the worm species treat the wastewater by consuming and digesting solid materials in the greywater and blackwater. In some embodiments, the biomedia treats the wastewater by trapping solid materials within the biomedia and allowing the treated water to flow through the first container. In some embodiments, the bacteria species treat the wastewater by consuming and digesting solid materials in the greywater and blackwater. In some embodiments, the one or more access hatches (e) allow for the monitoring and/or removal of undigested and/or unfiltered debris. In some embodiments, the one or more access hatches (e) allow for maintenance or upkeep of the one or more vermifilters. In some embodiments, the primary treated wastewater (e.g., greywater and blackwater) in the first container (b) flows into second container (c). In some embodiments, the primary treated wastewater flows into the second container (c) due to the presence of one or more holes (j) located on the side of the first container (b) of the first container. In some embodiments, the primary treated wastewater is filtered in the second container (c), to form secondary treated wastewater, by the same mechanism of action as the in the first container (b) to form secondary treated wastewater. That is, in some embodiments, the worm species treat the wastewater by consuming and digesting solid materials, the biomedia treats the wastewater by trapping solid materials within the biomedia and allowing the treated water to flow through the second container, and the bacteria species treat the wastewater by consuming and digesting solid materials in the greywater and blackwater. In some embodiments, the second container (c) further comprises one or more plant species. In some embodiments, the one or more plant species treat the primary treated wastewater by absorbing contaminants. In some embodiments, the secondary treated wastewater flows from the second container (c) to the first (d₁), second (d₂) and third (d₃) pipes of the one or more outlet pipes (d). In some embodiments, the secondary treated wastewater is sampled via the access point (f) to test contaminant levels.

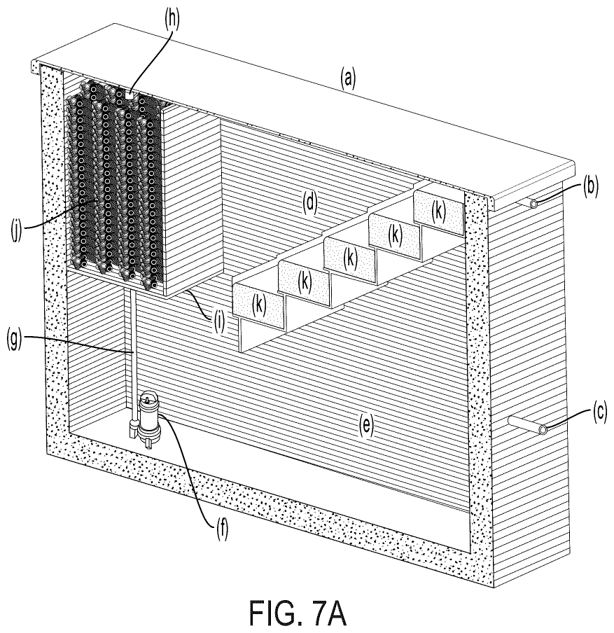

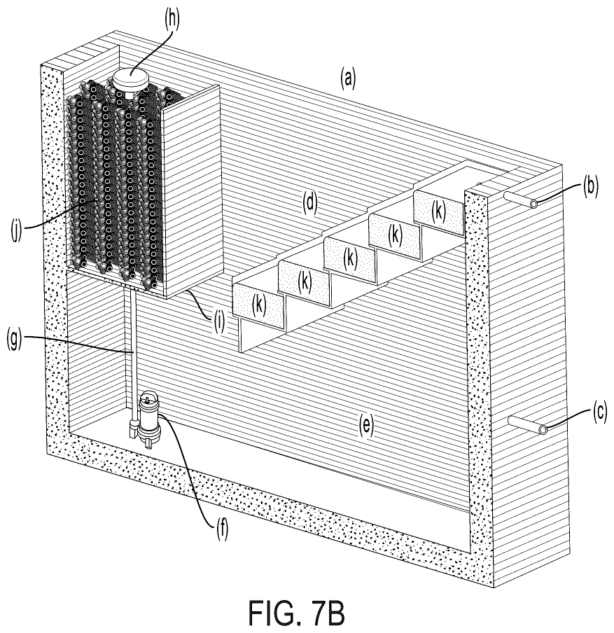

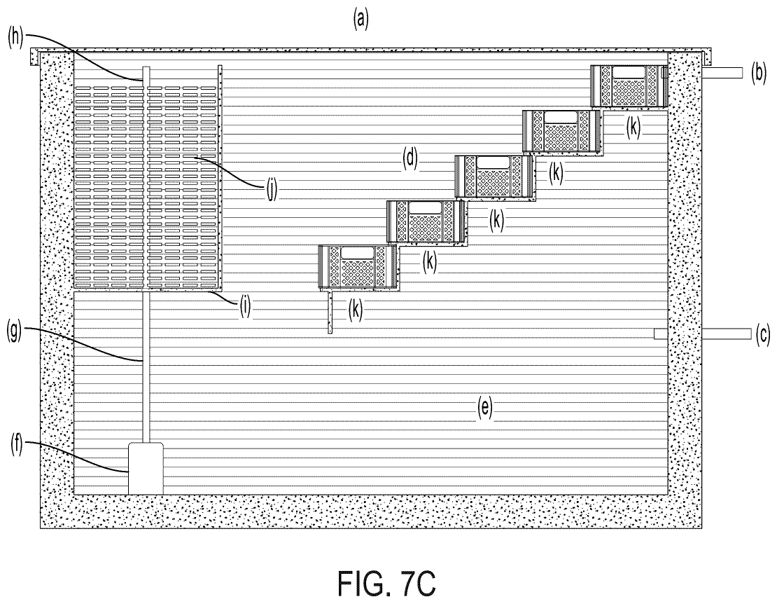

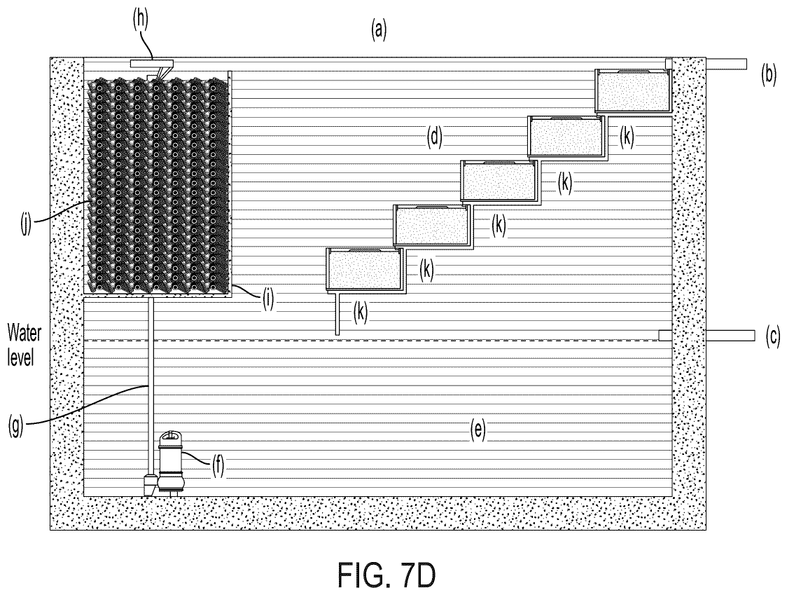

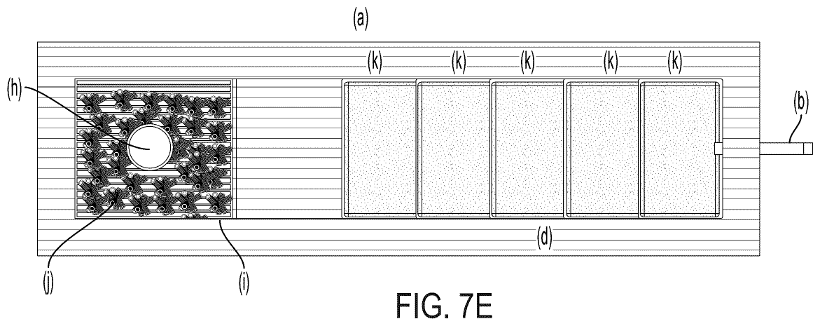

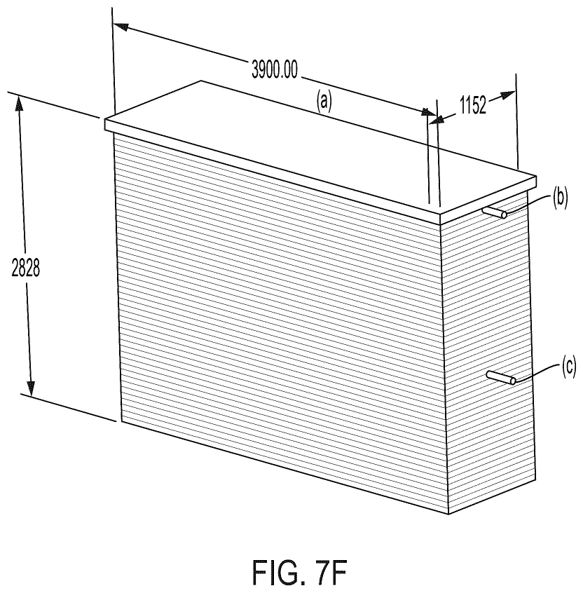

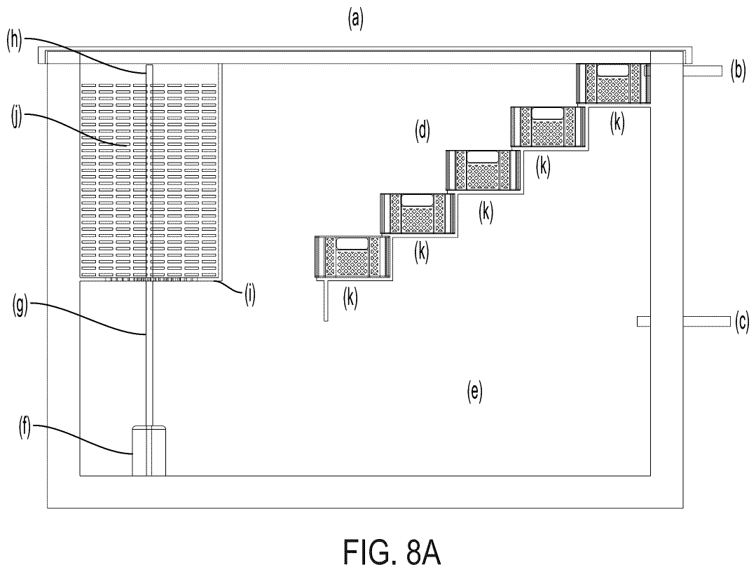

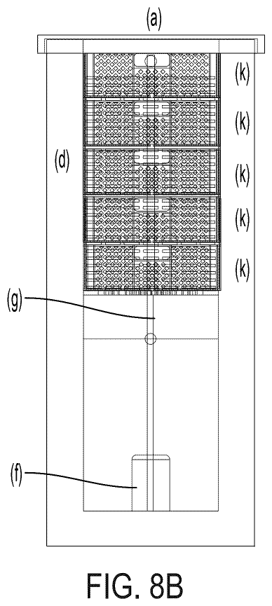

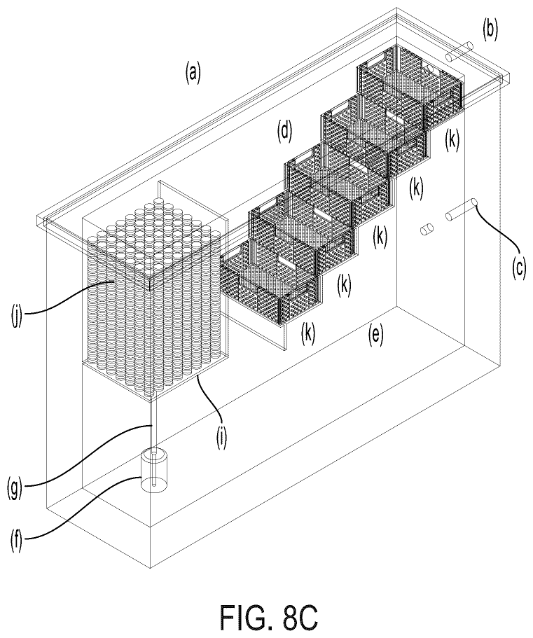

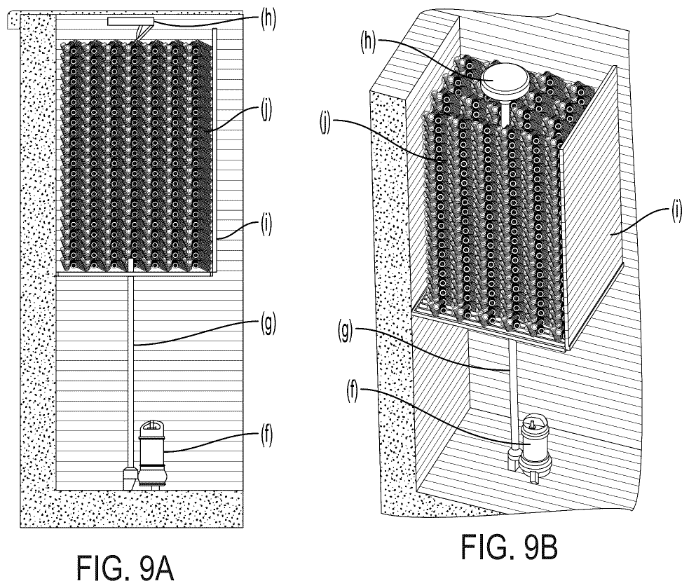

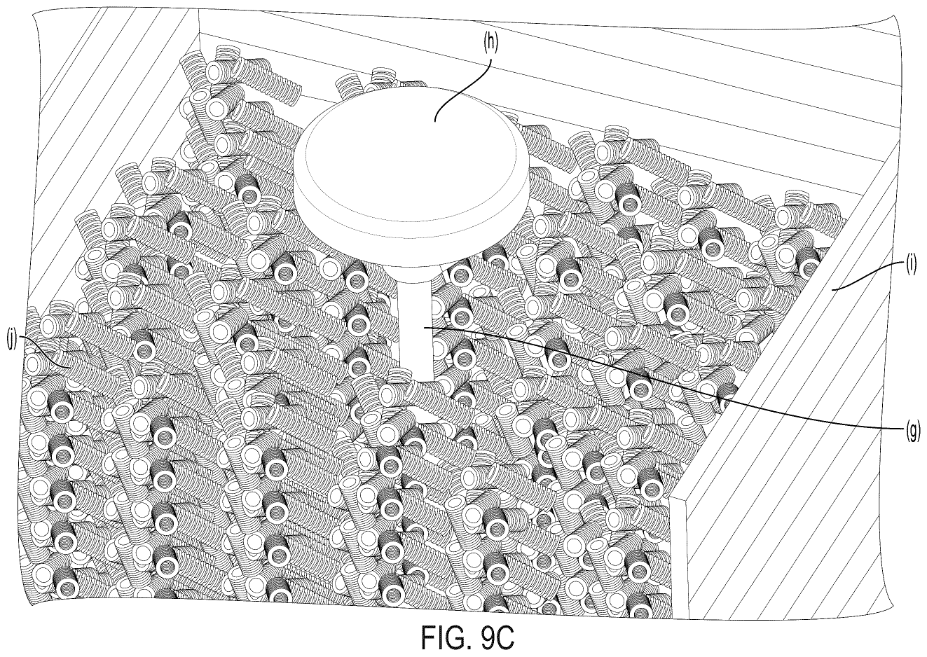

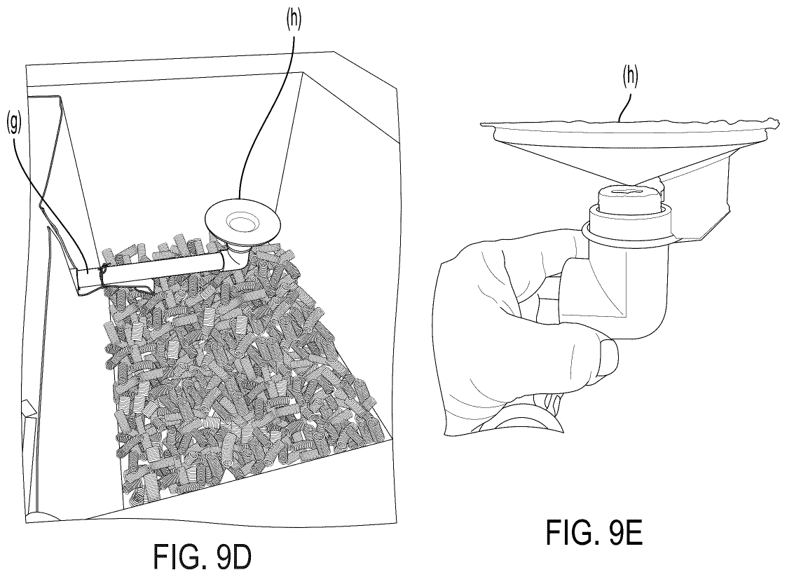

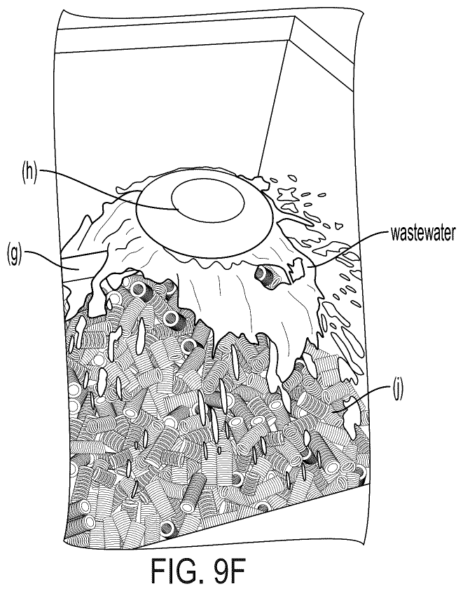

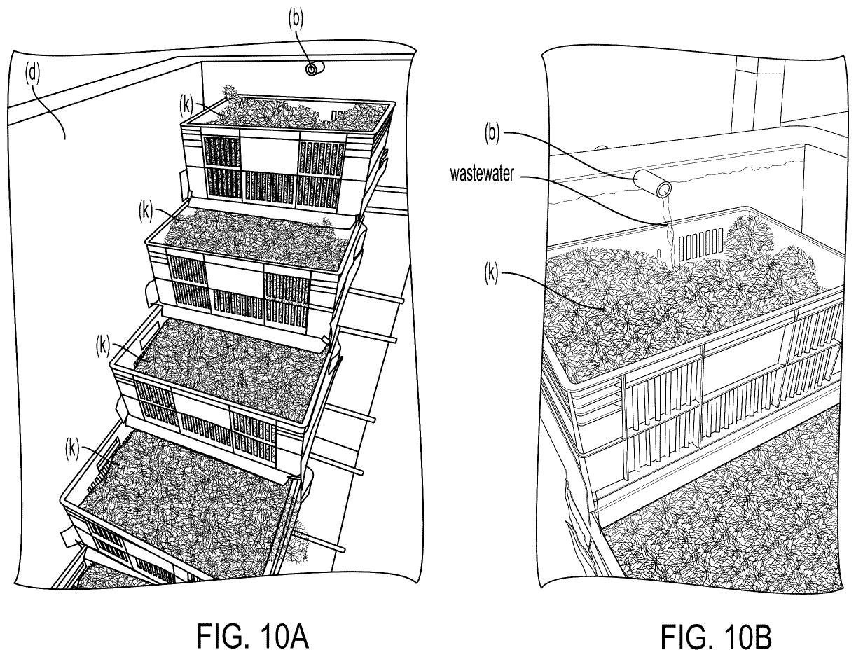

In some embodiments, the wastewater filtration system can be a wastewater filtration system as depicted in FIGS. 7A-7F and FIGS. 8A-8C, and comprising the components of FIGS. 9A-9F and FIGS. 10A-10B.

With reference to FIGS. 7A-7D, 8A, and 8C, the wastewater filtration system can include a container (a), one or more inlet pipes (b), one or more outlet pipes (c), a grate (d), e.g. a stair-step shaped grate, comprising one or more vermifilters (k), a sump tank (e), a pump (f), and a filter system, e.g. a trickling filter system, comprising a feed pipe (g), a water distribution system (h), a filter tank (i) and a biofilter comprising a biomedia (j), a microorganism and/or a macro-organism.

The one or more inlet pipes (b) can transport wastewater to the container (a); the grate (d) comprising one or more vermifilters (k) can treat the wastewater and transport the treated wastewater to the sump tank (e); the sump tank (e) can collect and store the treated wastewater; the pump (f) can transport the treated wastewater from the sump tank (e) to the filter system via the feed pipe (g); the water distribution system (h) can disperse (e.g., by spraying) the treated wastewater across the biomedia (j) in the filter tank, resulting in another treatment (e.g., a secondary treatment) of the wastewater; the filter tank (i) can transport the treated wastewater to the sump tank (e); the sump tank (e) can transport the treated wastewater to the one or more outlet pipes (c).

More specifically and with reference to FIGS. 7A-7D, 8A, and 8C, the components of the wastewater filtration system are fluidically connected and configured to transport wastewater to the system and transport treated wastewater out of the system. The one or more inlet pipes (b) can be fluidically connected to the container (a) and configured to transport wastewater, e.g., blackwater and/or greywater, to the container. The grate (d) comprising the one or more vermifilters (k) can be fluidically connected to the one or more inlet pipes (b) and configured to receive the wastewater, treat the wastewater and transport the wastewater to the sump tank (e), e.g., on a gravity gradient. The sump tank (e) can be fluidically connected to the grate (d) comprising the one or more vermifilters (k) and configured to receive and store the treated wastewater. The pump (f) can be fluidically connected to the sump tank (e) and configured to transport wastewater (e.g., primary treated wastewater) from the sump tank (e) to the feed pipe (g). The feed pipe (g) can be fluidically connected to the pump (f) and configured to transport wastewater from the pump (f) to the water distribution system (h). The water distribution system (h) can be fluidically connected to the biomedia (j) and configured to disperse the wastewater across the biomedia (j). The biomedia (j) can be fluidically connected to the filter tank (i) and configured to treat the wastewater. The filter tank (i) can be fluidically connected to the sump tank (e) and configured to transport the treated wastewater to the sump tank (e). The one or more outlet pipes (c) can be fluidically connected to the sump tank (e) and configured to receive the treated wastewater (e.g, secondary treated wastewater) from the sump tank (e) and transport it out of the container (a) via the one or more outlet pipes (c).

In some embodiments, the grate (d) can comprise one or more vermifilters (k). In some embodiments, each step of the stair-step shaped grate (d) can comprise a vermifilter (k). That is, in some embodiments, a vermifilter is located on each step of the stair-step shaped grate (d). In some embodiments, the one or more vermifilters comprise a biomedia, a macro-organism (e.g., one or more worm species and/or one or more plant species) and/or a microorganism (e.g., one or more bacteria species) as described in Section II.A. FIGS. 10A-10B depict exemplary vermifilters on each step of the stair-step shaped grate. In some embodiments, the grate (d) comprises one or more holes. In some embodiments, the size of the holes only allows vertical and/or horizontal flow of the wastewater while retaining the biomedia, macro-organism and/or microorganism in the grate.

FIGS. 9A-9E illustrate components of the filter system described above, which can comprise a pump (f), a feed pipe (g), a water distribution system (h), a filter tank (i), and a biomedia (j). In some embodiments, the water distribution system can be a sprinkler system comprising a sprinkler head. FIGS. 9D-9F depict exemplary sprinkler heads. In some embodiments, the filter tank (i) can be permeable. In some embodiments, the filter tank (i) can comprise biomedia (j). In some embodiments, the biomedia in the filter tank (i) can further comprise a macro-organism (e.g., one or more worm species) and/or a microorganism (e.g., one or more bacteria species). In some embodiments, the biomedia (j) in the filter tank (i) only comprises one or more bacteria species. In some embodiments, the filter tank (i) comprises one or more holes. In some embodiments, the size of the holes only allows vertical and/or horizontal flow of the wastewater while retaining the biomedia, macro-organism and/or microorganism in the filter tank.

In some embodiments, the design of the wastewater filtration system in any of FIGS. 7A-7F, FIGS. 8A-8C, FIGS. 9A-9F and FIGS. 10A-10B allows wastewater to flow through the container (a) on a gravity gradient and/or a pressure gradient. In some embodiments, the wastewater can flow through parts of the container on a gravity gradient. In some embodiments, the wastewater can flow through parts of the container on a pressure gradient. In some embodiments, the wastewater can flow through parts of the container on a gravity gradient and a pressure gradient. In some embodiments, the wastewater can undergo a primary treatment and a secondary treatment. In some embodiments, the wastewater can undergo three, four, five, six, seven or more treatments.

In some embodiments and with reference to FIGS. 7A-7D and FIGS. 8A-8C, the one or more inlet pipes (b) transfer greywater and/or blackwater to the container (a) to initiate the filtration process. In some embodiments, the greywater and/or blackwater flows horizontally and/or vertically across and/or through the stair-step shaped grate (d) comprising the one or more vermifilters (k) to undergo primary treatment. In some embodiments and as described in Section II.A., the one or more vermifilters can comprise a biomedia, a macro-organism (e.g., one or more worm species) and a microorganism (e.g., one or more bacteria species). In some embodiments, the biomedia treats or filters the wastewater by trapping solid materials so that the worm species and one or more bacteria species can consume and digest the solid materials. In some embodiments, after the last stair-step of the grate, the primary treated greywater and/or blackwater flows vertically on a gravity gradient to the sump tank (e) at the base of the container (a). In some embodiments, the primary treated greywater and/or blackwater is pumped vertically from the sump tank (e) to the filter system via the pump (f) and the feed pipe (g). In some embodiments, the primary treated greywater and/or blackwater undergo secondary treatment when the water distribution system (h) disperses (e.g., sprays or sprinkles) the primary treated greywater and/or blackwater over the filter biomedia (j). In some embodiments and as described in Section II.A., the one or more vermifilters can comprise a biomedia, a macro-organism (e.g., one or more worm species) and a microorganism (e.g., one or more bacteria species). In some embodiments, the biomedia treats or filters the wastewater by trapping solid materials so that the worm species and one or more bacteria species can consume and digest the solid materials. In some embodiments, the secondary treated greywater and/or blackwater flows vertically on a gravity gradient from the filter tank (i) to the sump tank (e). In some embodiments, the secondary treated greywater and/or blackwater flows horizontally from the sump tank (e) to the one or more outlet pipes (c). In other embodiments, the secondary treated greywater and/or blackwater is pumped vertically from the sump tank (e) to the filter system via the pump (f) and the feed pipe (g) one or more, two or more, three or more, four or more, five or more, six or more or seven or more times. That is, in some embodiments, the wastewater will be continually or repeatedly pumped through the container (a) from the sump tank (e) to the filter system before flowing to the one or more outlet pipes (c).

In particular embodiments, provided herein is a filtration system for treating wastewater, the system comprising: (a) one or more inlet pipes configured to transfer wastewater to the filtration system; (b) a first container fluidically connected to the one or more inlet pipes and configured to receive the wastewater from the one or more inlet pipes, wherein the first container comprises one or more first vermifilters configured to treat the wastewater to form a primary treated wastewater; (c) a second container fluidically connected to the first container and configured to receive the primary treated wastewater from the first container, wherein the second container comprises one or more second vermifilters and one or more plant species and the one or more second vermifilters and/or one or more plant species are configured to treat the primary treated wastewater to form a secondary treated wastewater; and (d) one or more outlet pipes fluidically connected to the second container and configured to transfer the secondary treated wastewater out of the filtration system, wherein a portion of the first container is within the second container.

In particular embodiments, provided herein is a filtration system for treating wastewater, the system comprising: (a) a first inlet pipe configured to transfer greywater to the filtration system and a second inlet pipe configured to transfer blackwater to the filtration system; (b) a first container fluidically connected to the first and second inlet pipes and configured to receive the greywater and the blackwater from the first and second inlet pipes, wherein the first container comprises a first vermifilter configured to treat the greywater and a second vermifilter configured to treat the blackwater, wherein the treated greywater and treated blackwater are combined in the first container to form a primary treated wastewater; (c) a second container fluidically connected to the first container and configured to receive the primary treated wastewater from the first container, wherein the second container comprises a third vermifilter and one or more plant species configured to treat the primary treated wastewater to form a secondary treated wastewater; and (d) an outlet pipe fluidically connected to the second container and configured to transfer the secondary treated wastewater out of the filtration system, wherein a portion of the first container is within the second container.

In particular embodiments, provided herein is a filtration system for treating wastewater, the system comprising: (a) one or more inlet pipes configured to transfer wastewater to the filtration system; (b) a container fluidically connected to the one or more inlet pipes and configured to receive the wastewater from the one or more inlet pipes, wherein the container comprises one or more vermifilters configured to treat the wastewater; and (c) one or more outlet pipes fluidically connected to the container and configured to transfer the treated wastewater out of the filtration system.

In particular embodiments, provided herein is a filtration system for treating wastewater, the system comprising: (a) one or more inlet pipes configured to transfer wastewater to the filtration system; (b) a container fluidically connected to the one or more inlet pipes and configured to receive the wastewater from the one or more inlet pipes, wherein the container comprises: (i) a grate comprising one or more vermifilters configured to treat the wastewater to form a primary treated wastewater; (ii) a sump tank configured to receive the primary treated wastewater; and (iii) a pump configured to pump the primary treated wastewater to a filter system, wherein the filter system is configured to treat the primary treated wastewater to form a secondary treated wastewater; and (c) one or more outlet pipes fluidically connected to the container and configured to transfer the secondary treated wastewater out of the filtration system.

In some aspects, provided herein is a method of using the wastewater filtration system provided herein. In some embodiments, the wastewater filtration system can be used in residential, municipal, commercial, agricultural and/or industrial areas.

### A. Vermifilter

Provided herein is a wastewater filtration system comprising one or more vermifilters. The ability of the provided wastewater filtration system to eliminate and/or reduce organic and/or inorganic contaminants from wastewater is based on the presence of one or more vermifilters in the filtration system. In some embodiments, a vermifilter is a biofilter comprising a biomedia and worm species. In some embodiments, the biomedia treats or filters wastewater by trapping solid materials in the wastewater so that the worm species can consume and digest the solid materials. Thus, the biomedia also provides a habitat for the worm species. In some embodiments, the vermifilter further comprises a microorganism (e.g., one or more bacteria species). In some embodiments, the one or more bacteria species also consume and digest solid materials in the wastewater. In some embodiments, the one or more bacteria species grow on the biomedia. In some embodiments, the vermifilters described herein can further comprise one or more plant species. In some embodiments, the one or more plant species are planted in the biomedia. In some embodiments, the one or more plant species further treats or filters the wastewater by absorbing certain contaminants (e.g., nitrogen).

In some embodiments, the wastewater filtration system provided herein comprises one or more vermifilters. In some embodiments, the wastewater filtration system comprises two vermifilters. In some embodiments, the wastewater filtration system comprises three vermifilters.

In some embodiments, the one or more vermifilters comprise a biomedia. In some embodiments, the biomedia provides a habitat for a worm species. In some embodiments, the biomedia aids in the treatment or filtration of the wastewater. In some embodiments, the biomedia treats or filters the wastewater by trapping solid materials and allowing the wastewater to flow through the biomedia. Thus, in some embodiments, the biomedia is water impermeable.

In some embodiments, different types of biomedia can be used in the vermifilter. In some embodiments, the biomedia comprises any biomedia known to support a worm species. In some embodiments, the biomedia comprises rock, gravel, cinder (e.g., volcanic rock or lava rock), soil, coir, compost, wood chip, bark chip, peat moss, straw and hay, and leaves, or any combination thereof. In some embodiments, the biomedia comprises rock. In some embodiments, the biomedia comprises lava rock.

In some embodiments, the biomedia comprises any biomedia of any size, e.g., diameter. In some embodiments, the biomedia in the vermifilter that treats or filters greywater has the same diameter as the biomedia in the vermifilter that treats or filters blackwater. In some embodiments, the biomedia in the vermifilter that treats or filters greywater has a different diameter than the biomedia in the vermifilter that treats or filters blackwater. In some embodiments, the biomedia in the vermifilter that treats or filters blackwater has a larger diameter than the biomedia in the vermifilter that treats or filters greywater. In some embodiments, this difference in diameter is due to the presence of larger solid materials in blackwater in greywater. In some embodiments, biomedia with a larger diameter can trap solid materials while simultaneously allowing wastewater to flow through the biomedia.

In some embodiments, the biomedia is fine to coarse in size. In some embodiments, the biomedia is fine to medium in size. In some embodiments, the biomedia is medium to coarse in size. In some embodiments, the biomedia is fine in size. In some embodiments, the biomedia is medium in size. In some embodiments, the biomedia is coarse in size. In some embodiments, the biomedia can comprise a combination of different sized biomedia.

In some embodiments, the biomedia in the vermifilter that treats or filters greywater is fine to medium in size. In some embodiments, the biomedia in the vermifilter that treats or filters greywater is fine in size. In some embodiments, the biomedia in the vermifilter that treats or filters blackwater is medium to coarse in size. In some embodiments, the biomedia in the vermifilter that treats or filters blackwater is medium to coarse in size.

In some embodiments, biomedia that is fine in size has a size (e.g., diameter) between about 3 mm and about 10 mm. In some embodiments, the biomedia has a diameter of about 3 mm, 4 mm, 5 mm, 6 mm, 7 mm, 8 mm, 9 mm or 10 mm. In some embodiments, biomedia that is medium in size has a size (e.g., diameter) greater than 10 mm but less than 30 mm. In some embodiments, the biomedia has a diameter of about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm or about 30 mm. In some embodiments, biomedia that is coarse in size has a size greater than 30 mm. In some embodiments, the biomedia that is coarse in size has a diameter of about 31 mm, about 32 mm, about 33 mm, about 34 mm, about 35 mm, about 36 mm about 37 mm, about 38 mm, about 39 mm or about 40 mm.

In some embodiments, the biomedia is about 1 inch to about 5 inches in length, and any value between the foregoing. In some embodiments, the biomedia is about 2 inches in length.

In some embodiments, only a single type of biomedia is used in the vermifilter. In some embodiments, a combination of different types of biomedia is used in the vermifilter. In some embodiments, the combination of different types of biomedia are mixed homogeneously (e.g., evenly dispersed such that they cannot be separated out). In some embodiments, the combination of different types of biomedia are mixed heterogeneously. In some embodiments, the different types of biomedia are layered. In some embodiments, the biomedia layers have different levels of resistance to water penetration or degree of water impermeability. In some embodiments, biomedia layered at the top has a higher degree of water impermeability whereas biomedia layered at the bottom has a lower degree of water impermeability. In some embodiments, the impermeable layers serve to slow the flow of the wastewater, making the flow more circuitous (less direct), thereby removing more solids from the water for the worms to eat. In some embodiments, when different types of biomedia are layered in the vermifilter, the biomedia at the top of the vermifilter provides a habitat for the worm species and the biomedia at the bottom is not suitable for a worm species.

In some embodiments, the worm species comprises any known worm species suitable for digesting solid materials. In particular embodiments, the worm species belongs to the genus Eisenia. In some embodiments, the worm species is Eisenia fetida, Eisenia andreii or Eisenia hortensis. In some embodiments, the worm species does not belong to the genus Eisenia. In some embodiments, the worm species is Eudrilus eugeniae, Amynthas gracillis, Perionyx excavates, or Lampito mauritii. In some embodiments, the worm species is Eisenia fetida. In some embodiments, the worm species is Eisenia andreii.

In some embodiments, any amount of the worm species is introduced to the vermifilter. In some embodiments, the amount of the worm species introduced to the vermifilter is optimized. In some embodiments, the worm species is added by weight. In some embodiments, about 1 kg of worms is added to the vermifilter. In some embodiments, the worm species is introduced to the vermifilter only once. In some embodiments, the worms will reproduce such that additional worms do not need to be introduced to the vermifilter. In some embodiments, the worm species is introduced to the vermifilter more than once over a period of weeks or months.

In some embodiments, the microorganism comprises one or more bacteria species. In some embodiments, the one or more bacteria species are artificially introduced to the one or more vermifilters. In some embodiments, any known bacteria species can be artificially introduced. In some embodiments, the one or more bacteria species naturally populate the one or more vermifilters. In some embodiments, the one or more bacteria species comprises any biofilm-forming bacteria species.

In some embodiments, the one or more vermifilters described herein can comprise an additional macro-organism. In some embodiments, the one or more vermifilters described herein comprise one or more plant species. In some embodiments, the one or more plant species are planted in the biomedia of the vermifilter. In some embodiments, the one or more plant species is a hydrophytic (“water-loving”) or wetland plant species. In some embodiments, any known hydrophytic plant species can be used in the wastewater filtration system provided herein. In some embodiments, any known hydrophytic plant native to the Hawaiian Islands can be used in the wastewater filtration system provided herein. In some embodiments, the one or more plant species is Aka'akai, Makaloa, Hala, or Bacopa Canna Lily. In some embodiments, certain hydrophytic plant species are incompatible with the vermifilters described herein due to excessive growth, which clogs the components of the wastewater filtration system. In some embodiments, the one or more vermifilters do not comprise Cyperus papyrus (e.g., Egyptian Papyrus).

### B. Inlet Pipe(s)

Provided herein is a wastewater filtration system comprising one or more pipes that transfers wastewater into the filtration systems. In some embodiments, the one or more pipes are termed inlet pipes. In some embodiments, the one or more inlet pipes are configured to transfer wastewater from a wastewater source to the filtration system. In some embodiments, the one or more inlet pipes transfer wastewater from the wastewater source to a first container of the wastewater filtration system. In some embodiments, the one or more inlet pipes are operably and/or fluidically connected to a side of the first side of the first container. In some embodiments, the one or more inlet pipes are connected to the side of the first container near the top of the first container, as depicted in any of the figures provided herein (see, e.g., FIG. 4, FIGS. 7A-7D, 7F, 8A, and 8C, among others). In some embodiments, the one or more inlet pipes do not come into contact with the second container, as depicted in FIG. 4.

In some embodiments, the one or more inlet pipes transfer greywater and/or blackwater to the first container. In some embodiments, the one or more inlet pipes transfer greywater and blackwater to the first container.

In some embodiments, the wastewater filtration system comprises one, two three, four, five or more inlet pipes. In some embodiments, the wastewater filtration system comprises one inlet pipe. In some embodiments, the one inlet pipe transfers greywater and/or blackwater to the first container. In some embodiments, the one inlet pipe transfers greywater to the first container. In some embodiments, the one inlet pipe transfers blackwater to the first container. In some embodiments, the one inlet pipe transfers greywater and blackwater to the first container.

In some embodiments, the wastewater filtration system comprises two inlet pipes. In some embodiments, the two inlet pipes include a first inlet pipe and a second inlet pipe. In some embodiments, the first or second inlet pipe transfers greywater to the first container and the other of the first or second inlet pipe transfers blackwater to the first container. In some embodiments, the first inlet pipe transfers blackwater to the first container and the second inlet pipe transfers greywater to the first container.

In some embodiments, the first inlet pipe and the second inlet pipe are parallel to each other. In some embodiments, the first inlet pipe and the second inlet pipe are perpendicular to each other. In some embodiments, the first inlet pipe and the second inlet pipe are stacked one on top of the other or side-by-side. In some embodiments, the first inlet pipe and the second inlet pipe are in contact with each other. In some embodiments, the first inlet pipe and the second inlet pipe are spaced apart. In some embodiments, the first inlet pipe and second inlet pipe are in parallel and spaced apart.

In some embodiments, the one or more inlet pipes have certain dimensions that aid in the transport of wastewater from the wastewater source to the first container of the wastewater filtration system. In some embodiments, the first and second inlet pipes have different diameters. In some embodiments, the first and second inlet pipes have the same diameter. In some embodiments, the inlet pipe carrying the blackwater has a larger diameter than the inlet pipe carrying the greywater. In some embodiments, the inlet pipe carrying the blackwater has the same diameter as the inlet pipe carrying the greywater. In some embodiments, the inlet pipe carrying the blackwater has a smaller diameter than the inlet pipe carrying the blackwater. In some embodiments, the one or more inlet pipes have a diameter of between about 1 inch and about 25 inches. In some embodiments, the one or more inlet pipes have a diameter between about 1 inch and about 5 inches, about 1 inch and about 10 inches, about 5 inches and about 15 inches, about 10 inches and about 20 inches, about 15 inches and about 25 inches, or about 20 inches and about 25 inches. In some embodiments, the one or more inlet pipes have a diameter between about 1 inch and 5 inches. In some embodiments, the one or more inlet pipes have a diameter of about 1 inch, about 2 inches, about 3 inches, about 4 inches or about 5 inches. In some embodiments, the one or more inlet pipes have a diameter of about 2 inches. In some embodiments, the one or more inlet pipes have a diameter of about 3 inches. In some embodiments, the one or more inlet pipes have a diameter of about 4 inches.

In some embodiments, the first and second inlet pipes have different lengths. In some embodiments, the first and second inlet pipes have the same length. In some embodiments, the inlet pipe carrying the blackwater has a longer length than the inlet pipe carrying the greywater. In some embodiments, the inlet pipe carrying the blackwater has the same length as the inlet pipe carrying the greywater. In some embodiments, the inlet pipe carrying the blackwater has a shorter length than the inlet pipe carrying the blackwater. In some embodiments, the first and second inlet pipes are at least 5 feet in length. In some embodiments, the one or more inlet pipes are between about 5 feet and about 100 feet in length. In some embodiments, the one or more inlet pipes are between about 5 feet and about 15 feet, about 10 feet and about 20 feet, about 15 feet and about 25 feet, about 20 feet and about 30 feet, about 25 feet and about 35 feet, about 30 feet and about 40 feet, about 35 feet and about 45 feet, about 40 feet and about 50 feet, about 45 feet and about 55 feet, about 50 feet and about 60 feet, about 55 feet and about 65 feet, about 60 feet and about 70 feet, about 65 feet and about 75 feet, about 70 feet and about 80 feet, about 75 feet and about 85 feet, about 80 feet and about 90 feet, about 85 feet and about 95 feet, or about 90 feet and about 100 feet.

Any known materials suitable for the construction of the one or more inlet pipes can be used in the filtration system provided herein. In some embodiments, the one or more inlet pipes are formed from any lightweight material. In some embodiments, the one or more inlet pipes are formed from polyvinyl chloride (PVC), polyethylene, polypropylene, or acrylonitrile butadiene styrene (ABS). In some embodiments, the one or more inlet pipes are formed from heavier weighted materials. In some embodiments, the one or more inlet pipes are formed from stainless steel, galvanized steel or cast iron.

### C. One or More Containers (e.g., Multi-Container Wastewater Filtration System)

Provided herein is a wastewater filtration system comprising one or more containers. In some embodiments, the one or more containers comprise a first and a second container. In some embodiments, wastewater is specifically treated in the first and second containers of the wastewater filtration system provided herein. In some embodiments, the first and second containers comprise one or more vermifilters. In some embodiments, the one or more vermifilters in the first and second container are the same. In some embodiments, the one or more vermifilters in the first and second container are different. In some embodiments, the first and second containers comprise any of the vermifilters described herein.

The one or more containers can be a closed container or an open container. A closed container is a container that is sealed or covered securely, such as a box. In some embodiments, the closed container is sealed or covered securely with a lid. An open container comprises a container that is not sealed or covered securely, such as a tray. In some embodiments, the open container does not have a lid. In some embodiments, the wastewater filtration system provided herein comprises one or more closed containers. In some embodiments, the wastewater filtration system provided herein comprises a combination of open and closed containers.

In some embodiments, the one or more containers can have any shape. In some embodiments, the one or more containers can have a rectangular shape, a square shape, a cylindrical shape or any other known shown. In some embodiments, the shape of the one or more containers is the same. In some embodiments, the shape of the one or more containers is different. In some embodiments, the wastewater filtration system comprises one or more rectangular containers and one or more cylindrical containers. In some embodiments, the wastewater filtration system comprises one or more rectangular containers.

In some embodiments, the wastewater filtration system comprises one, two, three, four, five, six or more containers. In some embodiments, the wastewater filtration system comprises six containers. In some embodiments, the wastewater filtration system comprises two containers, including a first container and a second container.

In some embodiments, the first container has one or more dimensions that is less than one or more dimensions of the second container. In some embodiments, the length, width and/or height of the first container is less than the length, width and/or height of the second container. In some embodiments, the first container has a length that is less than the length of the second container. In some embodiments, the first container has a width that is less than the width of the second container. In some embodiments, the first container has a height that is less than the height of the second container. In some embodiments, the first container has one or more dimensions that is greater than one or more dimensions of the second container. In some embodiments, the length, width and/or height of the first container is greater than the length, width and/or height of the second container. In some embodiments, the first container has a length that is greater than the length of the second container. In some embodiments, the first container has a width that is greater than the width of the second container. In some embodiments, the first container has a height that is greater than the height of the second container.

### 1. First Container

Provided herein is a wastewater filtration system comprising a first container.

In some embodiments, the first container is the site of primary treatment of the wastewater. In some embodiments, the first container houses a vermifilter as described herein, such as in in Section II.A., which treats the wastewater.

In some embodiments, a portion of the first container is within the second container. In some embodiments, the first container is detachable from the second container. In some embodiments, the first container is above ground. In some embodiments, the first container comprises a portion that is above ground and a portion that is below ground.

In some embodiments, the first container is an open container. In some embodiments, the first container is a closed container. In some embodiments, the closed container is further accessible. In some embodiments, the first container is a closed container with one or more access hatches on top of the first container. In some embodiments, the one or more access hatches are detachable from the first container. In some embodiments, the one or more access hatches are connected to the first container via a hinge. In some embodiments, the purpose of the access hatches is to provide access to the internal chambers of the first container for removal of undigested waste and/or vermicompost. In some embodiments, the one or more access hatches have a length of between about 10 inches and about 30 inches. In some embodiments, the one or more access hatches have a length of between about 10 inches and about 20 inches, or about 15 inches and about 25 inches, about 20 inches and about 30 inches. In some embodiments, the one or more access hatches have a length of between about 20 inches and about 30 inches. In some embodiments, the one or more access hatches have a length of about 20 inches, about 21 inches, about 22 inches, about 23 inches, about 24 inches, about 25 inches, about 26 inches, about 27 inches, about 28 inches, about 29 inches or about 30 inches. In some embodiments, the length of the one or more access hatches is about 24 inches.

In some embodiments, the first container comprises one or more chambers. In some embodiments, the first container comprises one or a single chamber. In some embodiments, the first container is a multi-chamber container as depicted in FIGS. 2 and 3. In some embodiments, the first container comprises 2 or more, 3 or more, 4 or more, 5 or more or 6 or more chambers. In some embodiments, the one or more chambers are subdivided by a structure (e.g., a wall, grate, tray or other similar structure). In some embodiments, structure does not permit the flow of water (e.g., is impermeable). In some embodiments, the structure permits the flow of water (e.g., permeable).

In some embodiments, the first container comprises a top chamber and a bottom chamber. In some embodiments, the top chamber and bottom chamber are separated by a grate. In some embodiments, the grate can be made from any material known in the art including fiberglass, plexiglass, plastic, galvanized steel, stainless steel, aluminum or any combination thereof. In some embodiments, the grate is water permeable. In some embodiments, the grate is porous. In some embodiments, the grate comprises one or more holes that allow water to flow from the top chamber to the bottom chamber of the first container. In some embodiments, the flow of water in this configuration is vertical flow filtration. In some embodiments, the one or more holes are evenly spaced. In some embodiments, the one or more holes have a staggered configuration. In some embodiments, the one or more holes are uniform in size. In some embodiments, the one or more holes have different sizes. In some embodiments, the holes have a diameter of between about 0.1 inches and 5 inches. In some embodiments, the holes have a diameter of between about 0.25 inches and 0.75 inches. In some embodiments, the holes have a diameter of about 0.5 inches.

In some embodiments, the top chamber of the first container is further subdivided into a first chamber and a second chamber. In some embodiments, the first chamber and the second chamber are divided by a wall. In some embodiments, the wall is water permeable. In some embodiments, the wall is water impermeable. In some embodiments, the wall can be made from any material known in the art including fiberglass, plexiglass, plastic, galvanized steel, stainless steel, aluminum or any combination thereof.

In some embodiments, the first container further comprises a structure, such as a tube, that originates in the top chamber to allow access to the bottom chamber of the first container. In some embodiments, the structure is a tube. In some embodiments, the tube allows access to the bottom chamber for the removal of sediment and other undigested solids. Thus, in some embodiments, the bottom chamber is a sedimentation basin. In some embodiments, the bottom chamber is cleared or emptied via the tube on a periodic basis. In some embodiments, the bottom chamber is cleared or emptied via the tube on a non-periodic basis. In some embodiments, the bottom chamber is cleared once every 1, 2, 3, 4, 5, 6, 7, 8, 9, 10, 11 or 12 months. In some embodiments, the bottom chamber is cleared once every 1, 2, 3, 4, 5, 6, 7, 8, 9 or 10 years. In some embodiments, the bottom chamber is cleared once every 5 years. In some embodiments, the tube can be made of any material known in the art. In some embodiments, the tube can be formed from fiberglass, plexiglass, plastic, galvanized steel, stainless steel, aluminum or any combination thereof. In some embodiments, the diameter of the tube is between about 5 inches and about 50 inches. In some embodiments, the diameter of the tube is between about 5 inches and about 15 inches, about 10 inches and about 20 inches, about 15 inches and about 25 inches, about 20 inches and about 30 inches, about 25 inches and about 35 inches, about 30 inches and about 40 inches, about 35 inches and about 45 inches, or about 40 inches and 50 inches. In some embodiments, the diameter of the tube is between about 15 inches and about 25 inches. In some embodiments, the diameter of the tube is about 15 inches, about 16 inches, about 17 inches, about 18 inches, about 19 inches or about 20 inches.

In some embodiments, the first container has certain dimensions that aid in the treatment of wastewater. In some embodiments, the first container has a length of between about 1 foot and 10 feet. In some embodiments, the first container is about 1 foot, 1 feet, 2 feet, 3 feet, 4 feet, 5 feet, 6 feet, 7 feet, 8 feet, 9 feet or 10 feet in length. In some embodiments, the first container is about 8 feet in length.

In some embodiments, the first container has a width of between about 1 and 6. In some embodiments, the first container has a width of about 1 foot, 2 feet, 3 feet, 4 feet, 5 feet or 6 feet. In some embodiments, the first container is about 4 feet in width.

In some embodiments, the first container has a height of between about 1 foot and about 5 feet. In some embodiments, the first container has a height of between about 1 foot and about 3 feet. In some embodiments, the first container has a height of between about 3 feet and about 5 feet In some embodiments, the first container has a height of between about 2 feet and about 4 feet. In some embodiments, the first container has a height of between about 3.5 feet and about 4.5 feet. In some embodiments, the first container has a height of about 3.5 feet, about 3.6 feet, about 3.7 feet, about 3.8 feet, about 3.9 feet, about 4 feet, about 4.1 feet, about 4.2 feet, about 4.3 feet, about 4.4 feet, or about 4.5 feet. In some embodiments, the first container has a height of about 4.2 feet.

In some embodiments, the first container can hold a certain volume of wastewater. In some embodiments, the first container has a wastewater capacity of between about 50 gallons and about 500 gallons. In some embodiments, the first container has a wastewater capacity of between about 100 gallons and about 400 gallons, about 150 gallons and about 350 gallons, or about 200 gallons and about 300 gallons. In some embodiments, the first container has a wastewater capacity of between about 100 gallons and about 200 gallons. In some embodiments, the first container has a wastewater capacity of about 100 gallons, about 110 gallons, about 120 gallons, about 130 gallons, about 140 gallons, about 150 gallons, about 160 gallons, about 170 gallons, about 180 gallons, about 190 gallons or about 200 gallons. In some embodiments, the first container has a capacity for 180 gallons of wastewater.

In particular embodiments, the wastewater flows through the first container on a gravity gradient. In some embodiments, the wastewater flows vertically through the first container. In some embodiments, the wastewater is transferred to the top chamber of the first container by the one or more inlet pipes. In some embodiments, the top chamber comprises one or more vermifilters as described herein. In some embodiments, the wastewater is filtered or treated by the one or more vermifilters in the top chamber. In some embodiments, solids and other materials in the wastewater are consumed and digested by the worm species in the top chamber. In some embodiments, the solids and other materials in the wastewater are consumed and digested by the one or more bacteria species in the top chamber. In some embodiments, a product of the filtering or treating of the wastewater in the top chamber are undigested solids, sediment, vermicompost and/or other solid materials. In some embodiments, the undigested solids, sediment, vermicompost and/or other solid materials flow from the top chamber to the bottom chamber. In some embodiments, undigested solids, sediment, vermicompost and/or other solid materials accumulate in the top chamber. In some embodiments, the treated wastewater (e.g., primary treated wastewater) flows to the bottom chamber. In some embodiments, the primary treated wastewater flows from the bottom chamber of the first container into the second container.

### 2. Second Container

Provided herein is a wastewater filtration system comprising a second container.

In some embodiments, the second container is the site of secondary treatment of the wastewater. In some embodiments, the second container houses a vermifilter as described in Section II.A., which treats the wastewater. In some embodiments, the second container is above ground.

In some embodiments, the second container is an open container. In some embodiments, the second container is a closed container.

In some embodiments, the second container comprises a portion that is above ground and/or below ground. In some embodiments, the second container is above ground. In some embodiments, the second container is below ground. In some embodiments, the second container is above and below ground.

In some embodiments, the second container further comprises a plant species. That is, in some embodiments, the one or more vermifilters housed in the second container comprise one or more plant species, as described in Section II.A. In some embodiments, the one or more plant species further treats the water by removing contaminants from the wastewater, which serve as nutrients for the plant species.

In some embodiments, the second container further comprises a bacteria species. That is, in some embodiments, the one or more vermifilters housed in the second container comprise one or more bacteria species, as described in Section II.A. In some embodiments, the one or more bacteria species further treats the water by consuming solid material in the wastewater.

In some embodiments, the second container has certain dimensions that aid in the treatment of wastewater. In some embodiments, the second container has a length of between about 1 foot and 20 feet. In some embodiments, the second container has a length of between about 2 feet and about 18 feet, about 4 feet and about 16 feet, about 6 feet and about 14 feet, or about 8 feet and about 12 feet. In some embodiments, the second container has a length of between about 2 feet and about 4 feet, about 3 feet and about 5 feet, about 4 feet and about 6 feet, about 5 feet and about 7 feet, about 6 feet and about 8 feet, about 7 feet and about 9 feet, about 8 feet and about 10 feet, about 9 feet and about 11 feet, about 10 feet and about 12 feet, about 11 feet and about 13 feet, about 12 feet and about 14 feet, about 13 feet and about 15 feet, about 14 feet and about 16 feet, about 15 feet and about 17 feet, about 16 feet and about 18 feet, about 17 feet and about 19 feet, or about 18 feet and about 20 feet. In some embodiments, the second container has a length of between about 16 feet and about 17 feet. In some embodiments, the second container has a length of about 16 feet, about 16.1 feet, about 16.2 feet, about 16.3 feet, about 16.4 feet, about 16.5 feet, about 16.6 feet, about 16.7 feet, about 16.8 feet, about 16.9 feet or about 17 feet. In some embodiments, the second container has a length of about 16.6 feet.

In some embodiments, the second container has a width of between about 1 foot and 10 feet. In some embodiments, the second container has a width of between about 2 feet and about 8 feet or about 4 feet and about 6 feet. In some embodiments, the second container has a width of between about 1 foot and about 3 feet, about 2 feet and about 4 feet, about 3 feet and about 5 feet, about 4 feet and about 6 feet, about 5 feet and about 7 feet, about 6 feet and about 8 feet, about 7 feet and about 9 feet, or about 8 feet and about 10 feet. In some embodiments, the second container has a width between about 6 feet and about 7 feet. In some embodiments, the second container has a width of about 6 feet, about 6.1 feet, about 6.2 feet, about 6.3 feet, about 6.4 feet, about 6.5 feet, about 6.6 feet, about 6.7 feet, about 6.8 feet, about 6.9 feet or about 7 feet. In some embodiments, the second container has a width of about 6.2 feet.

In some embodiments, the second container has a height of between about 1 foot and about 5 feet. In some embodiments, the second container has a height of between about 1 foot and about 3 feet, about 2 feet and about 4 feet, or about 3 feet and about 5 feet. In some embodiments, the second container has a height of between about 1.5 feet and about 2.5 feet. In some embodiments, the second container has a height of about 1.5 feet, about 1.6 feet, about 1.7 feet, about 1.8 feet, about 1.9 feet, about 2.0 feet, about 2.1 feet, about 2.2 feet, about 2.3 feet, about 2.4 feet or about 2.5 feet. In some embodiments, the second container has a height of about 2.3 feet.

In some embodiments, the second container can hold a certain volume of wastewater. In some embodiments, the second container has a wastewater capacity of greater than 100 gallons. In some embodiments, the second container has a wastewater capacity of between about 100 gallons and about 1500 gallons. In some embodiments, the second container has a wastewater capacity of between about 500 gallons and about 1500 gallons, about 800 gallons and about 1200 gallons, or about 900 gallons and about 1100 gallons. In some embodiments, the second container has a wastewater capacity of between about 100 gallons and about 300 gallons, about 200 gallons and about 400 gallons, about 300 gallons and about 500 gallons, about 400 gallons and about 600 gallons, about 500 gallons and about 700 gallons, about 600 gallons and about 800 gallons, about 700 gallons and about 900 gallons, about 800 gallons and about 1000 gallons, about 900 gallons and about 1100 gallons, about 1000 gallons and about 1200 gallons, about 1100 gallons and about 1300 gallons, about 1200 gallons and about 1400 gallons, or about 1300 gallons and about 1500 gallons. In some embodiments, the second container has a wastewater capacity of between about 900 gallons and about 1100 gallons. In some embodiments, the second container has a wastewater capacity of about 1000 gallons. In some embodiments, the second container has a wastewater capacity greater than 1500 gallons.

In particular embodiments, the wastewater flows through the second container on a gravity gradient. In some embodiments, as the wastewater flows through the second container, any remaining undigested solids in the wastewater can be absorbed, digested or consumed by the one or more worm species, one or more bacteria species and/or one or more water species to form the secondary treated wastewater. In some embodiments, the secondary treated wastewater is transferred out of the filtration system via the one or more outlet pipes.

### D. Outlet Pipe(s)

Provided herein is a wastewater filtration system comprising one or more pipes, such as one or more pipes that transfer treated wastewater away from the filtration system. In some embodiments, the wastewater has been treated once and is referred to as primary treated wastewater. In some embodiments, the wastewater has been treated more than one, such as twice. In some embodiments, wastewater that has been treated twice is secondary treated wastewater. In some embodiments, the wastewater can be treated three or more times.

In some embodiments, the wastewater filtration system provided herein transports treated wastewater from the filtration system to a disposal site. In some embodiments, the wastewater filtration system transports the treated wastewater to the disposal site by way of one or more outlet pipes. In some embodiments, the one or more outlet pipes are operably and/or fluidically connected by any means known in the art. In some embodiments, the one or more outlet pipes are perpendicular to each other. In some embodiments, the one or more outlet pipes are arranged in parallel. In some embodiments, the one or more outlet pipes are not operably and/or fluidically connected to each other.

In some embodiments, the one or more outlet pipes comprise three pipes including a first, second and third pipe. In some embodiments, the first, second and third pipes are operably and/or fluidically connected to each other. In some embodiments, the first, second and third pipes are operably and/or fluidically connected with a pipe tee fitting. In some embodiments, the first and second pipes are perpendicular to the third pipe.

In some embodiments, the first and second pipes are perforated to collect the treated wastewater. In some embodiments, the perforations allow the treated wastewater to flow from the second container to the first and second pipes. In some embodiments, the first and second pipes transfer the treated wastewater to the third pipe. In some embodiments, the third pipe transfers the treated wastewater to the disposal site.

In some embodiments, the perforations comprise any shape known in the art. In some embodiments, the perforations are round, square, or slots. In some embodiments, the perforations are evenly spaced. In some embodiments, the perforations are staggered. In some embodiments, the perforations are uniform in size. In some embodiments, the perforations are not uniform in size. In some embodiments, the perforations have a diameter between about 0.1 and 1 inches. In some embodiments, the perforations have a diameter between about 0.25 and 0.75 inches. In some embodiments, the perforations have a diameter of about 0.5 inches.

In some embodiments, the one or more pipes comprises an access point that allows for the collection or sampling of the treated wastewater for testing levels of contaminants. Any known method for assessing contaminants in water can be used. In some embodiments, the biochemical oxygen demand (BOD) and/or total suspended solids (TSS) of the treated wastewater can be assessed via the access point.

In some embodiments, the access point is an extension of the one or more outlet pipes. In some embodiments, the access point is covered. In some embodiments, the access point is covered using any means known in the art. In some embodiments, the access point is covered with a screw cap. In some embodiments, the access point is covered with a stopper. In some embodiments, the access point is exposed in the second container, such as being located above the biomedia in the second container. In some embodiments, the access point is not exposed in the second container, such as being located beneath the biomedia in the second container.

In some embodiments, the one or more outlet pipes have certain dimensions that aid in the transport of treated wastewater from the second container to the disposal site. In some embodiments, the one or more outlet pipes have different diameters. In some embodiments, the one or more outlet pipes have the same diameter. In some embodiments, the first, second and third outlet pipes have the same diameter. In some embodiments, the first second and third outlet pipes have different diameters.

In some embodiments, the one or more outlet pipes have a diameter of between about 1 inch and about 25 inches. In some embodiments, the one or more outlet pipes have a diameter between about 1 inch and about 5 inches, about 1 inch and about 10 inches, about 5 inches and about 15 inches, about 10 inches and about 20 inches, about 15 inches and about 25 inches, or about 20 inches and about 25 inches. In some embodiments, the pipes of the one or more outlet pipes have a diameter between about 1 inch and 5 inches. In some embodiments, the pipes of the one or more outlet pipes have a diameter of about 1 inch, about 2 inches, about 3 inches, about 4 inches or about 5 inches. In some embodiments, the pipes of the one or more outlet pipes have a diameter of 4 inches.

In some embodiments, the one or more outlet pipes have different lengths. In some embodiments, the one or more outlet pipes have the same length. In some embodiments, the first and second outlet pipes have the same length. In some embodiments, the first and second outlet pipes have different lengths. In some embodiments, the first and second outlet pipes have a different length than the third outlet pipe. In some embodiments, the first and second outlet pipes of the outlet piping system each have a shorter length than the third outlet pipe.

In some embodiments, the first and second outlet pipes of the one or more outlet pipes are between about 1 foot to 5 feet in length.

In some embodiments, the third outlet pipe is between about 5 feet and about 100 feet in length. In some embodiments, the third outlet pipe is between about 5 feet and about 15 feet, about 10 feet and about 20 feet, about 15 feet and about 25 feet, about 20 feet and about 30 feet, about 25 feet and about 35 feet, about 30 feet and about 40 feet, about 35 feet and about 45 feet, about 40 feet and about 50 feet, about 45 feet and about 55 feet, about 50 feet and about 60 feet, about 55 feet and about 65 feet, about 60 feet and about 70 feet, about 65 feet and about 75 feet, about 70 feet and about 80 feet, about 75 feet and about 85 feet, about 80 feet and about 90 feet, about 85 feet and about 95 feet, or about 90 feet and about 100 feet. In some embodiments, the third outlet pipe of the one or more outlet pipes is greater than 100 feet in length.

Any known materials suitable for the construction of the one or more outlet pipes can be used in the filtration system provided herein. In some embodiments, the one or more outlet pipes are formed from lightweight material. In some embodiments, the one or more outlet pipes are formed from polyvinyl chloride (PVC), polyethylene, polypropylene, acrylonitrile butadiene styrene (ABS), stainless steel, galvanized steel or cast iron.

In some embodiments, the one or more outlet pipes are connected to the side of the second container near the top of the second container, as depicted in any of the figures provided herein (see, e.g., FIG. 3, among others). In some embodiments, the one or more outlet pipes do not come into contact with the first container, as depicted in FIG. 1 or FIG. 2, among others.

In some embodiments, the one or more outlet pipes do not comprise a first, second and third pipe.

In some embodiments, the one or more outlet pipes are connected to the side of any container described herein, e.g., in Section II.E., near the middle of the container, as depicted in any of the figures provided herein (see, e.g., FIGS. 7A-7D, 7F, 8A, and 8C, among others).

### E. Container-Based Wastewater Filtration System

In some aspects, provided herein is a wastewater filtration system comprised in one or more containers.

In some embodiments, a container is fluidically connected to one or more inlet pipes to receive untreated wastewater and one or more outlet pipes to transfer the treated wastewater out of the container. In some embodiments, the one or more inlet pipes comprise any of the one or more inlet pipes described in Section II.B. In some embodiments, the one or more outlet pipes comprise any of the one or more outlet pipes described in Section II.D.

In some embodiments, the container is configured to treat the wastewater one or more, two or more, three or more, four or more, five or more, six or more, or seven or more times. In some embodiments, the container continually treats the wastewater.

In some embodiments, the container can have any shape. In some embodiments, the container can have a rectangular shape, a square shape, a cylindrical shape or any other known shown. In some embodiments, the wastewater filtration system comprises a rectangular container.

The container can be a closed container or an open container. A closed container is a container that is sealed or covered securely, such as a box. In some embodiments, the closed container is sealed or covered securely with a lid. An open container comprises a container that is not sealed or covered securely, such as a tray. In some embodiments, the open container does not have a lid. In some embodiments, the wastewater filtration system provided herein comprises a single closed container. In some embodiments, the wastewater filtration system provided herein can include multiple containers (open and/or closed). In some embodiments, the wastewater filtration system has the shape shown in any of FIGS. 7A-7F or FIGS. 8A-8C. In some embodiments, the wastewater filtration system has any of the components shown in FIGS. 7A-7F, FIGS. 8A-8C, FIGS. 9A-9F and FIGS. 10A-10B.

In some embodiments, the container is a closed container that comprises a portion that is above ground and/or below ground. In some embodiments, the container is a closed container that is above ground. In some embodiments, the container is a closed container that is below ground. In some embodiments, the container is a closed container that is above and below ground. In some embodiments, the container is an open container that comprises a portion that is above ground and/or below ground. In some embodiments, the container is an open container that is above ground. In some embodiments, the container is an open container that is below ground. In some embodiments, the container is an open container that is above and below ground.

In some embodiments, the container comprises one or more compartments. In some embodiments, the container is configured to allow the wastewater to flow from one compartment to another. In some embodiments, the wastewater flows from compartment to compartment on a gravity gradient. In some embodiments, the wastewater flows from compartment to compartment on a pressure gradient. In some embodiments, the wastewater flows from compartment to compartment on a gravity gradient followed by a pressure gradient. In some embodiments, the wastewater flows from compartment to compartment, in order, on a gravity gradient, a pressure gradient and a gravity gradient. In some embodiments, the wastewater flows from compartment to compartment on a continual gravity gradient followed by a pressure gradient.

In some embodiments, the container comprises a grate, a sump tank, a pump, and/or a filter system. In some embodiments, the compartment(s) of the container include a grate, a sump tank, a pump, and/or a filter system. In some embodiments, the wastewater filtration system comprises any of the containers, grates, sump tanks, pumps and filter systems described below. In some embodiments, an exemplary configuration of the container, grate, sump tank, pump and filter system is shown in any of FIGS. 7A-7F, FIGS. 8A-8C, FIGS. 9A-9F and FIGS. 10A-10B.

### 1. Container

In some embodiments, the wastewater filtration system comprises a container. In some embodiments, the container has certain dimensions that aid in the treatment of wastewater.

In some embodiments, the container is shown as (a) in FIGS. 7A-7F and 8A-8C.

In some embodiments, the container has a length of between about 100 feet and about 500 feet, and any value between the foregoing. In some embodiments, the container has a length of between about 100 feet and about 200 feet, about 150 feet and about 250 feet, about 200 feet and about 300 feet, about 250 feet and about 350 feet, about 300 feet and about 400 feet, about 350 feet and about 450 feet, about 400 feet and about 500 feet. In some embodiments, the container has a length of between about 100 feet and about 450 feet, between about 100 feet and about 400 feet, between about 100 feet and about 350 feet, between about 100 feet and about 300 feet, between about 100 feet and about 250 feet, between about 100 feet and about 200 feet, between about 100 feet and about 150 feet, between about 150 feet and about 500 feet, between about 150 feet and about 450 feet, between about 150 feet and about 400 feet, between about 150 feet and about 350 feet, between about 150 feet and about 300 feet, between about 150 feet and about 250 feet, between about 150 feet and about 200 feet, between about 200 feet and about 500 feet, between about 200 feet and about 450 feet, between about 200 feet and about 400 feet, between about 200 feet and about 350 feet, between about 200 feet and about 300 feet, between about 200 feet and about 250 feet, between about 250 feet and about 500 feet, between about 250 feet and about 450 feet, between about 250 feet and about 400 feet, between about 250 feet and about 350 feet, between about 250 feet and about 300 feet, between about 300 feet and about 500 feet, between about 300 feet and about 450 feet, between about 300 feet and about 400 feet, between about 300 feet and about 350 feet, between about 350 feet and about 500 feet, between about 350 feet and about 450 feet, between about 350 feet and about 400 feet, between about 400 feet and about 500 feet, between about 400 feet and about 450 feet, between about 450 feet and about 500 feet. In some embodiments, the container has a length of about 300 feet, about 310 feet, about 315 feet, about 325 feet, about 335 feet, about 345 feet, or about 350 feet. In some embodiments, the container has a length of about 325 feet. In some embodiments, the container has a length of about 3900 inches.

In some embodiments, the container has a length of between about 2 feet and about 10 feet, and any value between the foregoing. In some embodiments, the container has a length of about 2 feet, about 3 feet, about 4 feet, about 5 feet, about 6 feet, about 7 feet, about 8 feet, about 9 feet or about 10 feet. In some embodiments, the container has a length of about 4 feet. In some embodiments, the container has a length of about 8 feet.

In some embodiments, the container has a width of between about 70 feet and about 120 feet, and any value between the foregoing. In some embodiments, the container has a width of between about 70 feet and about 80 feet, about 75 feet and about 85 feet, about 80 feet and about 90 feet, about 85 feet and about 95 feet, about 90 feet and about 100 feet, about 95 feet and about 105 feet, about 100 feet and about 110 feet, about 105 feet and about 115 feet, or about 110 feet and about 120 feet. In some embodiments, the container has a width of between about 70 feet and about 120 feet, between about 70 feet and about 110 feet, between about 70 feet and about 100 feet, between about 70 feet and about 90 feet, between about 70 feet and about 80 feet, between about 80 feet and about 120 feet, between about 80 feet and about 110 feet, between about 80 feet and about 100 feet, between about 80 feet and about 90 feet, between about 90 feet and about 120 feet, between about 90 feet and about 110 feet, between about 90 feet and about 100 feet, between about 100 feet and about 120 feet, or between about 100 feet and about 110 feet. In some embodiments, the container has a width of about 90 feet, about 91 feet, about 92 feet about 93 feet, about 94 feet, about 95 feet, about 96 feet, about 97 feet, about 98 feet, about 99 feet or about 100 feet. In some embodiments, the container has a width of about 96 feet. In some embodiments, the container has a width of about 1152 inches.

In some embodiments, the container has a width of between about 1 foot and about 5 feet, and any value between the foregoing. In some embodiments, the container has a width of about 1 foot, about 2 feet, about 3 feet, about 4 feet or about 5 feet. In some embodiments, the container has a width of about 2 feet. In some embodiments, the container has a width of about 4 feet.

In some embodiments, the container has a height of between about 100 feet and about 500 feet, and any value between the foregoing. In some embodiments, the container has a height of between about 100 feet and about 200 feet, about 150 feet and about 250 feet, about 200 feet and about 300 feet, about 250 feet and about 350 feet, about 300 feet and about 400 feet, about 350 feet and about 450 feet, about 400 feet and about 500 feet. In some embodiments, the container has a height of between about 100 feet and about 450 feet, between about 100 feet and about 400 feet, between about 100 feet and about 350 feet, between about 100 feet and about 300 feet, between about 100 feet and about 250 feet, between about 100 feet and about 200 feet, between about 100 feet and about 150 feet, between about 150 feet and about 500 feet, between about 150 feet and about 450 feet, between about 150 feet and about 400 feet, between about 150 feet and about 350 feet, between about 150 feet and about 300 feet, between about 150 feet and about 250 feet, between about 150 feet and about 200 feet, between about 200 feet and about 500 feet, between about 200 feet and about 450 feet, between about 200 feet and about 400 feet, between about 200 feet and about 350 feet, between about 200 feet and about 300 feet, between about 200 feet and about 250 feet, between about 250 feet and about 500 feet, between about 250 feet and about 450 feet, between about 250 feet and about 400 feet, between about 250 feet and about 350 feet, between about 250 feet and about 300 feet, between about 300 feet and about 500 feet, between about 300 feet and about 450 feet, between about 300 feet and about 400 feet, between about 300 feet and about 350 feet, between about 350 feet and about 500 feet, between about 350 feet and about 450 feet, between about 350 feet and about 400 feet, between about 400 feet and about 500 feet, between about 400 feet and about 450 feet, between about 450 feet and about 500 feet. In some embodiments, the container has a height of about 200 feet, about 205 feet, about 210 feet, about 215 feet, about 220 feet, about 225 feet, about 230 feet, about 235 feet, about 240 feet, about 245 feet or about 250 feet. In some embodiments, the container has a height of about 325 feet. In some embodiments, the container has a height of about 326 feet. In some embodiments, the container has a height of about 2828 inches.

In some embodiments, the container has a height of between about 1 foot and about 10 feet, and any value between the foregoing. In some embodiments, the container has a height of about 1 foot, about 2 feet, about 3 feet, about 4 feet about 5 feet, about 6 feet about 7 feet about 8 feet about 9 feet or about 10 feet. In some embodiments, the container has a height of about 3 feet. In some embodiments, the container has a height of about 7 feet.

In some embodiments, the container has a length of 3900 inches, a width of 1152 inches, and a height of 2828 inches. In some embodiments, the container has a length of 8 feet, a width of 4 feet, and a height of 7 feet. In some embodiments, the container has a length of 4 feet, a width of 2 feet and a height of 3 feet.

A skilled artisan would be able to determine the amount of wastewater in gallons the wastewater filtration system can hold based on the dimensions described above. In some embodiments, the container can hold a certain volume of wastewater. In some embodiments, the container has a wastewater capacity up to about 600 gallons. In some embodiments, the container has a wastewater capacity of at least 600 gallons. In some embodiments, the wastewater filtration system treats about 600 gallons per day. In some embodiments, the wastewater filtration system can treat significantly less than 600 gallons per day. In some embodiments, the wastewater filtration system treats less than about 600 gallons per day, less than about 500 gallons per day, less than about 400 gallons per day, less than about 300 gallons per day, less than about 200 gallons per day, less than about 100 gallons per day, or less than about 50 gallons per day.

In some embodiments, the wastewater filtration system comprises two or more containers. In some embodiments, the wastewater filtration system comprises at least two containers. In some embodiments, the wastewater filtration system comprises two containers. That is, in some embodiments, the wastewater filtration system can be a two-container wastewater filtration system containing any of the components described in Sections II.E.1.a to II.E.1.d.

In some embodiments, the two-container wastewater filtration system can include a first container and a second container are not in contact with each other or do not touch each other. In some embodiments, the two-container wastewater filtration system is different from the multi-container wastewater filtration system described in Sections II.C.1 and II.C.2. In some embodiments, each container of the two-container wastewater filtration system can include any of the components described herein in Sections II.E.1.a to II.E.1.d. In some embodiments, the two-container wastewater filtration system comprises a first container and a second container.

In some embodiments, the first container of the two-container wastewater filtration system can include a grate comprising one or vermifilters, a sump tank, a pump and a feed pipe as described below. In some embodiments, the first container of the two-container wastewater filtration system treats the wastewater a first time (i.e., a primary treatment) and the second container of the two-container wastewater filtration system treats the wastewater a second time (i.e., a secondary treatment). In some embodiments, after secondary treatment, the treated wastewater is transported out of the second container. In other embodiments, after secondary treatment, the treated wastewater is transported to the first container to undergo a second cycle of treatment, wherein a cycle comprises treatment in the first container and the second container. In some embodiments, the treated wastewater undergoes one or more, two or more, three or more, four or more, five or more, six or more, or seven or more cycles of treatment. Thus, in some embodiments, the first container is the site of primary wastewater and secondary wastewater treatment. In some embodiments, the first container is the site of previously treated secondary treated wastewater.

In some embodiments, the first container of the two-container wastewater filtration system has a grate comprising one or more vermifilters, a sump tank, a pump and a filter system. In some embodiments, one or more inlet pipes can be fluidically connected to the first container and configured to transport wastewater (e.g., blackwater and/or greywater) to the grate. The grate can be fluidically connected to the one or more inlet pipes and configured to receive the wastewater, treat the wastewater and transport the wastewater to the sump tank. In some embodiments, the wastewater can flow horizontally, vertically and/or through the grate on a gravity gradient to the sump tank. The sump tank can be fluidically connected to the grate and configured to receive and store the treated wastewater. In some embodiments, the pump can be fluidically connected to the sump tank and configured to transport wastewater from the sump tank to the feed pipe. In some embodiments, the feed pipe can be configured to transport the wastewater from the first container to a water distribution system. In some embodiments, the water distribution system is contained in the second container of the two-container wastewater filtration system. Thus, in some embodiments, part of the filter system is contained within the first container of the two-container wastewater filtration system and another part of filter system is contained within the second container of the two-container wastewater filtration system.

In some embodiments, the second container of the two-container wastewater filtration system has a water distribution system, a filter tank, biomedia and a sump tank. In some embodiments, the feed pipe can be fluidically connected to the pump of the first container and configured to transport wastewater (e.g., primary treated wastewater or previously secondary treated wastewater) from the pump of the first container to the water distribution system of the second container. In some embodiments, the water distribution system can be fluidically connected to the biomedia and configured to disperse the wastewater across the biomedia. In some embodiments, the filter tank can be fluidically connected to the biomedia and configured to receive the wastewater, treat the wastewater and transport the wastewater to the sump tank. In some embodiments, the wastewater flows vertically on a gravity gradient from the filter tank to the sump tank. In some embodiments, one or more outlet pipes can be fluidically connected to the second container of the two-container wastewater filtration system and configured to receive the wastewater from the sump tank. In other embodiments, one or more outlet pipes can be fluidically connected to the first container and configured to transport treated wastewater from the second container to the first container to undergo one or more cycles of treatment. In some embodiments, one or more of the one or more outlet pipes can be fluidically connected to the second container and configured to transport treated wastewater out of the second container and one or more of the one or more outlet pipes can be fluidically connected to the first container and configured to transport treated wastewater from the second container to the first container to undergo one or more cycles of treatment. In some embodiments, the wastewater is continually flowing out of the second container to, e.g., a disposal site, and between the first container and the second container.

### a) Grate

In some embodiments, the container has a grate. In some embodiments, the grate is the site of primary wastewater treatment. In some embodiments, the grate is the site of secondary wastewater treatment.

In some embodiments, the wastewater is delivered to the grate via the one or more inlet pipes. In some embodiments, the grate is positioned above the sump tank.

In some embodiments, the grate comprises one or more vermifilters. In some embodiments, the wastewater is treated as it flows across and down the grate. In some embodiments, the one or more vermifilters comprise a biomedia, a microorganism (e.g., bacteria species) and/or a macro-organism (e.g., worm species). In some embodiments, the one or more vermifilters comprise any of the one or more vermifilters described in Section II.A. As described in Section II.A., the one or more vermifilters of the grate treat the wastewater resulting in a primary treated wastewater. In some embodiments, the one or more vermifilters are a biofilter comprising a biomedia, one or more macro-organisms (e.g., worm species) and one or more microorganisms (e.g., bacteria species). In some embodiments, the biomedia treats or filters wastewater by trapping solid materials in the wastewater so that the worm species can consume and digest the solid materials. Thus, the biomedia also provides a habitat for the worm species. In some embodiments, the vermifilter further comprises a microorganism (e.g., one or more bacteria species). In some embodiments, the one or more bacteria species also consume and digest solid materials in the wastewater. In some embodiments, the one or more bacteria species grow on the biomedia. In some embodiments, the one or more vermifilters described herein can further comprise one or more plant species. In some embodiments, the one or more plant species are planted in the biomedia. In some embodiments, the one or more plant species further treats or filters the wastewater by absorbing certain contaminants (e.g., nitrogen).

In some embodiments, the grate described herein promotes horizontal and/or vertical flow of wastewater from the one or more inlet pipes to the sump tank. In some embodiments, the grate described herein promotes horizontal flow of the wastewater from the one or more inlet pipes to the sump tank. In some embodiments, the grate described herein promotes vertical flow of the wastewater from the one or more inlet pipes to the sump tank. In some embodiments, the grate described herein promotes horizontal and vertical flow of the wastewater from the one or more inlet pipes to the sump tank. In some embodiments, a benefit of horizontal and vertical flow is the prevention of clogging of the one or more vermifilters with solid wastes in the wastewater.

In some embodiments, the grate is permeable or porous, which promotes horizontal and/or vertical flow of the wastewater from the one or more inlet pipes to the sump tank. In some embodiments, the grate comprises one or more holes that allow water to flow from the grate to the sump tank. In some embodiments, the one or more holes are evenly spaced. In some embodiments, the one or more holes have a staggered configuration. In some embodiments, the one or more holes are uniform in size. In some embodiments, the one or more holes have different sizes. In some embodiments, the holes comprise a diameter that only allows vertical flow filtration of the wastewater from the grate to the sump, and not the biomedia. In some embodiments, the holes have a diameter of between about 0.1 inches and 5 inches. In some embodiments, the holes have a diameter of between about 0.25 inches and 0.75 inches. In some embodiments, the holes have a diameter of about 0.5 inches.

In some embodiments, the grate comprises a stair-step. In some embodiments, the stair-step shaped grate comprises one or more, two or more, three or more, four or more, five or more, six or more, or seven or more stair-steps. In some embodiments, the wastewater flows horizontally and vertically across each stair-step shaped grate. In some embodiments, each stair-step of the stair-step shaped grate comprises a vermifilter. In some embodiments, the vermifilter on each step is the same. In some embodiments, the vermifilter on each step is different. In some embodiments, the vermifilter on each step comprises the same biomedia. In some embodiments, the vermifilter on each step comprises different biomedia. In some embodiments, the vermifilter on each step comprises biomedia that is the same size. In some embodiments, the vermifilter on each step comprises biomedia that is different in size. In some embodiments, the biomedia on the steps closer to the one or more inlet pipes is medium to coarse in size. In some embodiments, the biomedia on the steps closer to the sump tank is fine to medium in size. In some embodiments, such gradient in biomedia size improves removal of solid and other wastes in the wastewater.

In some embodiments, the vermifilter on each step of the stair-step grate comprises the same one or more worm species, bacteria species and/or plant species. In some embodiments, the vermifilter on each step of the stair-step grate comprises different one or more worm species, bacteria species and/or plant species. In some embodiments, the vermifilter on each step of the stair-step grate comprises the same one or more worm species.

In some embodiments, the vermifilter on each step of the stair-step grate comprises a different one or more worm species. In some embodiments, the vermifilter on each step of the stair-step grate comprises the same one or more bacteria species. In some embodiments, the vermifilter on each step of the stair-step grate comprises a different one or more bacteria species. In some embodiments, the vermifilter on each step of the stair-step grate comprises the same one or more plant species. In some embodiments, the vermifilter on each step of the stair-step grate comprises different one or more plant species. In some embodiments, the vermifilter on each step of the stair-step grate comprises the same one or more worm species, bacteria species and/or plant species.

In some embodiments, when the wastewater flows to or reaches the last stair-step of the stair-step shaped grate, it flows down a gravity gradient to a sump tank below the grate.

In some embodiments, exemplary configurations of the stair-step shaped grate is shown as (d) in FIGS. 7A-7E, 8A, 8C, 10A and 10B.

In some embodiments, the grate is not stair-step shaped. In some embodiments, the grate has a flat shape. In some embodiments, the grate has a flat shape that is horizontal in the container. In some embodiments, the grate has a flat shape that is positioned on a downward slope in the container. In some embodiments, wastewater flows from the one or more inlet pipes to the sump tank by flowing diagonally on a gravity gradient across the flat grate on a downward slope.

In some embodiments, the grate can be made from any material known in the art including fiberglass, plexiglass, plastic, galvanized steel, stainless steel, aluminum or any combination thereof.

### b) Sump Tank

In some embodiments, the container has a sump tank. In some embodiments, the sump tank is positioned beneath the grate and filter system.

In some embodiments, the sump tank is an enclosed structure. In some embodiments, the sump tank is a physical structure comprising one or more walls. In some embodiments, the sump tank comprises a circular walled structure. In some embodiments, the sump tank comprises a square walled structure. In some embodiments, the sump tank comprises a rectangular walled structure. In some embodiments, the sump tank can be made from any material known in the art including fiberglass, plexiglass, plastic, galvanized steel, stainless steel, aluminum, concrete or any combination thereof.

In some embodiments, the sump tank is not an enclosed structure. In some embodiments, the sump tank refers to the general area where the primary treated wastewater collects in the base of the container. In some embodiments, when the sump tank is not an enclosed structure, its walls are defined by the walls of the container. In some embodiments, the sump tank is positioned below the grate. In some embodiments, the sump tank is positioned at the base of the container. In some embodiments, the sump tank collects the primary treated wastewater flowing from the grate. In some embodiments, the sump tank stores the primary treated wastewater until it flows to the filter system via the pump.

In some embodiments, the sump tank is a partially enclosed structure.

In some embodiments, the sump tank is shown as (e) in FIGS. 7A-7E, 8B and 8C.

### c) Pump

In some embodiments, the container has a pump. In some embodiments, the pump is positioned at the base of the container. In some embodiments, the pump is positioned in the sump tank. In some embodiments, the pump creates a pressure gradient to allow the treated wastewater to flow from the sump tank to the filter system. In some embodiments, the pump comprises any pump suitable for the transport of a liquid, e.g., wastewater. In some embodiments, the pump comprises a mechanical pump. In some embodiments, the mechanical pump is a centrifugal pump, a reciprocating pump, a rotary pump or a hydraulic pump. In other embodiments, the pump is electrically powered. In other embodiments, the pump is manually powered, e.g., by a combustion engine. Any pump known in the art and suitable for water intake can be used.

In some embodiments, the pump is shown as (f) in FIGS. 7A-7D, 8A-8C and 9A-9B.

### d) Filter System

In some embodiments, the container has a filter system. In some embodiments, the filter system is positioned at the top of the container. In some embodiments, the filter system is positioned at the top of the container and across from the grate. In some embodiments, the filter system is positioned across from the grate in any direction. In some embodiments, the filter system is positioned above the sump tank. In some embodiments, the filter system is positioned across from the grate and above the sump tank. In some embodiments, the filter system uses macro-organisms (e.g., a worm species), microorganisms and/or biomedia to treat the wastewater (e.g., blackwater and/or greywater). In some embodiments, the filter system uses a vermifilter as described in Section II.A. to remove solid materials in wastewater, e.g., blackwater and/or greywater, to generate a secondary treated wastewater. In some embodiments, the vermifilter of the filter system comprises biomedia and one or more one or more microorganisms. In some embodiments, the vermifilter of the filter system comprises biomedia and one or more one or more macro-organisms (e.g., one or more worm species). In some embodiments, the vermifilter of the filter system comprises biomedia, one or more microorganisms, and one or more macro-organisms. In some embodiments, the vermifilter is contained in the filter tank, which is described below. In some embodiments, the biomedia treat or filter wastewater by trapping solid materials in the wastewater so that the microorganisms and/or macro-organisms can consume and digest the solid materials.

In some embodiments, the filter system comprises more than one component. In some embodiments, the components are operably and/or fluidically connected. In some embodiments, the components are operably and/or fluidically connected to treat wastewater. In some embodiments, the filter system treats wastewater one or more, two or more, three or more, four or more, five or more, six or more, or seven or more times. In some embodiments, the filter system continually treats wastewater. In some embodiments, the filter system comprises a feed pipe, a water distribution system, filter media, and a filter tank.

In some embodiments, the feed pipe delivers primary treated wastewater (or previously secondary treated wastewater) from the sump tank to the water distribution system. In some embodiments, the feed pipe is operably connected to the pump. In some embodiments, the filter system comprises more than one feed pipe. In some embodiments, the filter system comprises two or more feed pipes. In some embodiments, any known material suitable for construction of the feed pipe can be used. In some embodiments, the feed pipe is formed from any lightweight material. In some embodiments, the feed pipe is formed from polyvinyl chloride (PVC), polyethylene, polypropylene, or acrylonitrile butadiene styrene (ABS). In some embodiments, the feed pipe is formed from heavier weighted materials. In some embodiments, the feed pipe is formed from stainless steel, galvanized steel or cast iron.

In some embodiments, the water distribution system disperses the primary treated wastewater (or previously secondary treated wastewater) from the sump tank over the filter tank. In some embodiments, the primary treated wastewater (or previously secondary treated wastewater) is delivered to the water distribution system via the feed pipe. In some embodiments, the water distribution system is operably connected to the feed pipe. In some embodiments, the water distribution system can comprise any water distribution system known in the art. In some embodiments, the water distribution system comprises a water spraying device. In some embodiments, the water distribution system comprises one or more sprinklers.

In some embodiments, the filter tank is the site of secondary treatment of the wastewater. In some embodiments, the filter tank further removes solids and other wastes from the primary treated wastewater. In some embodiments, the filter tank receives primary treated wastewater (or previously secondary treated wastewater) from the water distribution system (e.g., one or more sprinklers).

In some embodiments, the filter tank contains a biofilter. In some embodiments, the biofilter comprises biomedia, a microorganism (e.g., a bacteria species) and/or a macro-organism (e.g., a worm species). In some embodiments, the biofilter comprises a biomedia and a bacteria species. In some embodiments, the biofilter comprises one or more biomedia and one or more bacteria species. In some embodiments, the biomedia has a high surface area for one or more bacteria species to colonize the biomedia.

In some embodiments, the biomedia comprises any of the biomedia disclosed herein. In some embodiments, the biomedia comprises plastic, rock, gravel, cinder (e.g., volcanic rock or lava rock), soil, coir, compost, wood chip, bark chip, peat moss, straw and hay, and leaves, or any combination thereof. In some embodiments, the biomedia comprises rock. In some embodiments, the biomedia comprises lava rock. In some embodiments, the biomedia is a plastic electrical conduit. In some embodiments, the plastic electrical conduit is about ¾ inch in diameter and about 2 inches in length.

In some embodiments, the one or more bacteria species are artificially introduced to the biomedia in the filter tank. In some embodiments, any known bacteria species can be artificially introduced. In some embodiments, the one or more bacteria species naturally populate the biomedia in the filter tank. In some embodiments, the one or more bacteria species comprises any biofilm-forming bacteria species. In some embodiments, the filter tank comprises a vermifilter. In some embodiments, the filter tank comprises any of the vermifilters described herein comprising a biomedia, worm species and bacteria species, including the vermifilters described in Section II.A.

In some embodiments, the filter tank can comprise any known shape. In some embodiments, the filter tank is a structure comprising one side wall and one bottom wall. In some embodiments, the side wall is connected to the bottom wall to form a structure that can hold any of the biomedia, bacteria species and/or worm species described herein. In some embodiments, the filter tank has a circular or cylindrical shape.

In some embodiments, the filter tank can be a structure comprising more than one sidewall and one bottom wall. In some embodiments, the more than one sidewalls are connected to the bottom wall. In some embodiments, the more than one side walls are connected to the bottom wall to form a structure that can hold any of the biomedia, bacteria species and/or worm species described herein. In some embodiments, the filter tank has four sidewalls. In some embodiments, the filter tank has a rectangular shape. In some embodiments, the filter tank has a square shape.

In some embodiments, the filter tank is configured such that the secondary treated wastewater is returned to the sump tank. In some embodiments, the filter tank is permeable. In some embodiments, the permeability of the bottom wall and/or the one or more sidewalls allows the secondary treated wastewater to flow to the sump tank. In some embodiments, the secondary treated wastewater flows to the sump tank on a gravity gradient. In some embodiments, the bottom wall of the filter tank is permeable. In some embodiments, the one or more side walls of the filter tank are permeable. In some embodiments, all side walls of the filter tank are permeable. In some embodiments, the bottom wall and one or more side walls of the filter tank are permeable. In an embodiment where the filter tank has a rectangular shape, the bottom wall and all four side walls are permeable. In some embodiments, when the secondary treated wastewater is returned to the sump tank, the secondary treated wastewater can either exit the container via the one or more outlet pipes or be returned to the filter system from the sump tank via the pump and feed pipe. Thus, in some embodiments, the filter tank is the site for two or more, three or more, four or more, five or more, six or more, or seven or more treatments of the wastewater.

In some embodiments, the bottom wall and/or the one or more sidewalls of the filter tank comprises one or more holes. In some embodiments, the one or more holes are evenly spaced. In some embodiments, the one or more holes have a staggered configuration. In some embodiments, the one or more holes are uniform in size. In some embodiments, the one or more holes have different sizes. In some embodiments, the holes have a diameter of between about 0.1 inches and 5 inches. In some embodiments, the holes have a diameter of between about 0.25 inches and 0.75 inches. In some embodiments, the holes have a diameter of about 0.5 inches. In some embodiments, the permeability of the bottom wall allows for aeration of the wastewater as it is being treated. In some embodiments, aeration promotes growth of microorganisms (e.g., a bacteria species) that can breakdown solids and other wastes in the wastewater.

In some embodiments, the filter system is a trickling filter system. A trickling filter is an aerobic wastewater treatment system that uses a bed of media, such as any of the biomedia provided herein, to treat wastewater. In the trickling filter system, the wastewater is sprayed over the media (e.g., biomedia). Trickling filters are known in the art. Accordingly, any trickling filter design can be used in accordance with the filtration systems provided herein.

In some embodiments, the trickling filter system is an aerated trickling filter system. Aerated trickling filters are known in the art. An aerated trickling filter is substantially identical to a trickling filter with the exception that an aerated trickling filter is designed to be an open-air system. Accordingly, any aerated trickling filter design can be used in accordance with the filtration systems provided herein.

In some embodiments, the aerated trickling filter system has the components (f), (g), (h), (i) and (j) as shown in FIGS. 7A-7E, 8A-8C and 9A-9F.

In some embodiments, the filter system is not a trickling filter system. In some embodiments, a filter system that is not a trickling filter system does not contain a water distribution system.

### EXEMPLARY EMBODIMENTS

Among the provided embodiments are:

1. A filtration system for treating wastewater, the system comprising:
(a) one or more inlet pipes configured to transfer wastewater to the filtration system;
(b) a first container fluidically connected to the one or more inlet pipes and configured to receive the wastewater from the one or more inlet pipes, wherein the first container comprises one or more first vermifilters configured to treat the wastewater to form a primary treated wastewater;
(c) a second container fluidically connected to the first container and configured to receive the primary treated wastewater from the first container, wherein the second container comprises one or more second vermifilters and one or more plant species and the one or more second vermifilters and/or one or more plant species are configured to treat the primary treated wastewater to form a secondary treated wastewater; and
(d) one or more outlet pipes fluidically connected to the second container and configured to transfer the secondary treated wastewater out of the filtration system, wherein a portion of the first container is within the second container.

2. The wastewater filtration system of embodiment 1, wherein the first container is detachable from the second container.

3. The wastewater filtration system of embodiment 1 or embodiment 2, wherein a side of the first container is flush with a side of the second container.

4. The wastewater filtration system of any one of embodiments 1-3, wherein the wastewater flows through the wastewater filtration system on a gravity gradient.

5. The wastewater filtration system of any one of embodiments 1-4, wherein the wastewater flows into the first container to undergo a primary treatment and the primary treated wastewater flows into the second container to undergo a secondary treatment.

6. The wastewater filtration system of embodiment 5, wherein:
(a) the wastewater flows from the one or more inlet pipes into the first container to undergo the primary treatment;
(b) the primary treated wastewater flows from the first container into the second container to undergo the secondary treatment; and
(c) the secondary treated wastewater flows from the second container into the one or more outlet pipes.

7 The wastewater filtration system of embodiment 5 or embodiment 6, wherein the primary and secondary treatment reduce the amount of solid material in the wastewater.

8. The wastewater filtration system of any one of embodiments 5-7, wherein the primary and secondary treatment reduce the amount of suspended solids in the wastewater.

9. The wastewater filtration system of any one of embodiments 5-8, wherein the secondary treated wastewater has an average biochemical oxygen demand (BOD) measurement of <25 mg/L.

10. The wastewater filtration system of any one of embodiments 5-9, wherein the secondary treated wastewater has an average total suspended solid (TSS) measurement of <30 mg/L.

11. The wastewater filtration system of any one of embodiments 1-10, wherein the one or more inlet pipes transfer wastewater from a wastewater source to the first container.

12. The wastewater filtration system of any one of embodiments 1-11, wherein the one or more inlet pipes are operably and/or fluidically connected to a side of the first container near the top of the first container.

13. The wastewater filtration system of any one of embodiments 1-12, wherein the one or more inlet pipes do not come into contact with the second container.

14. The wastewater filtration system of any one of embodiments 1-13, wherein the one or more inlet pipes transfer greywater and/or blackwater to the first container.

15. The wastewater filtration system of any one of embodiments 1-14, wherein the one or more inlet pipes transfer greywater and blackwater to the first container.

16. The wastewater filtration system of any one of embodiments 1-15, wherein the wastewater filtration system comprises one inlet pipe.

17. The wastewater filtration system of any one of embodiments 1-15, wherein the wastewater filtration system comprises two inlet pipes.

18. The wastewater filtration system of embodiment 17, wherein the two inlet pipes include a first inlet pipe and a second inlet pipe.

19. The wastewater filtration system of embodiment 18, wherein the first inlet pipe and the second inlet pipe are parallel to each other.

20. The wastewater filtration system of embodiment 18 or embodiment 19, wherein the first inlet pipe has a larger diameter than the second inlet pipe.

21. The wastewater filtration system of any one of embodiments 18-20, wherein the first or second inlet pipe transfers greywater to the first container and the other of the first or second inlet pipe transfers blackwater to the first container.

22. The wastewater filtration system of any one of embodiments 1-21, wherein the first inlet pipe transfers blackwater to the first container and the second inlet pipe transfers greywater to the first container.

23. The wastewater filtration system of any one of embodiments 1-22, wherein the one or more outlet pipes is operably and/or fluidically connected to a side of the second container.

24. The wastewater filtration system of any one of embodiments 1-23, wherein the one or more outlet pipes is operably and/or fluidically connected to an internal and external side of the second container.

25. The wastewater filtration system of any one of embodiments 1-24, wherein the one or more outlet pipes is located near the top of the second container.

26. The wastewater filtration system of any one of embodiments 1-25, wherein the one or more outlet pipes does not come into contact with the first container.

27. The wastewater filtration system of any one of embodiments 1-26, wherein the one or more outlet pipes collects secondary treated wastewater and transfers it to a disposal site.

28. The wastewater filtration system of any one of embodiments 1-27, wherein the one or more outlet pipes comprises an access point to allow for sampling and testing of the treated wastewater.

29. The wastewater filtration system of any one of embodiments 1-28, wherein the one or more outlet pipes comprises one or more pipes operably and/or fluidically connected with a pipe tee fitting.

30. The wastewater filtration system of any one of embodiments 1-30, wherein the one or more outlet pipes comprises a first, second and third pipe operably and/or fluidically connected with a pipe tee fitting.

31. The wastewater filtration system of embodiment 30, wherein the first and second pipes are perpendicular to the third pipe.

32. The wastewater filtration system of embodiment 30 or embodiment 31, wherein the first and second pipes are perforated to collect the treated wastewater.

33. The wastewater filtration system of any one of embodiments 30-32, wherein the first and second pipes transfer the secondary treated wastewater to the third pipe.

34. The wastewater filtration system of any one of embodiments 30-33, wherein the third pipe transports the secondary treated wastewater to a disposal site.

35. The wastewater filtration system of any one of embodiments 1-34, wherein the first container has one or more dimensions that is less than one or more dimensions of the second container.

36. The wastewater filtration system of any one of embodiments 1-35, wherein the first container has a length that is less than the length of the second container.

37. The wastewater filtration system of any one of embodiments 1-36, wherein the first container has a width that is less than the width of the second container.

38. The wastewater filtration system of any one of embodiments 1-37, wherein the first container has one or more dimensions that is greater than one or more dimensions of the second container.

39. The wastewater filtration system of any one of embodiments 1-38, wherein the first container has a height that is greater than the height of the second container.

40. The wastewater filtration system of any one of embodiments 1-39, wherein the first container comprises one or more access hatches situated on top of the first container.

41. The wastewater filtration system of embodiment 40, wherein the one or more access hatches are detachable from the first container.

42. The wastewater filtration system of embodiment 40 or embodiment 41, wherein the one or more access hatches are connected to the first container via a hinge.

43. The wastewater filtration system of any one of embodiments 1-42, wherein the first container is a multi-chamber container.

44. The wastewater filtration system of any one of embodiments 1-43, wherein the first container comprises a top chamber and a bottom chamber.

45. The wastewater filtration system of embodiment 44, wherein the top chamber is separated from the bottom chamber by a grate.

46. The wastewater filtration system of embodiment 45, wherein the grate is porous.

47. The wastewater filtration system of any one of embodiments 44-46, wherein the bottom chamber can be accessed from the top chamber via a tube.

48. The wastewater filtration system of any one of embodiments 44-47, wherein the bottom chamber is a sedimentation basin.

49. The wastewater filtration system of any one of embodiments 44-48, wherein the bottom chamber comprises one or more holes to allow the primary treated wastewater to flow into the second container.

50. The wastewater filtration system of any one of embodiments 44-49, wherein the top chamber is subdivided into a first chamber and a second chamber.

51. The wastewater filtration system of embodiment 50, wherein the first chamber and the second chamber are subdivided by a wall.

52. The wastewater filtration system of any one of embodiments 1-51, wherein the one or more vermifilters in the first container are housed in the top, single chamber.

53. The wastewater filtration system of any one of embodiments 1-51, wherein the one or more vermifilters in the first container are housed in the top, first and second chambers.

54. The wastewater filtration system of any one of embodiments 1-53, wherein the one or more vermifilters comprise a biomedia providing a habitat for a worm species.

55. The wastewater filtration system of embodiment 54, wherein the biomedia comprises rock, cinder (e.g., volcanic rock or lava rock), gravel, soil, coir, compost, wood chip, bark chip or any combination thereof.

56. The wastewater filtration system of embodiment 54 or embodiment 55, wherein the biomedia is lava rock.

57. The wastewater filtration system of any one of embodiments 54-56, wherein the biomedia is fine to coarse in size.

58. The wastewater filtration system of any one of embodiments 54-57, wherein the biomedia is medium to coarse in size.

59. The wastewater filtration system of any one of embodiments 54-58, wherein the worm species digests solid materials in the wastewater.

60. The wastewater filtration system of any one of embodiments 54-59, wherein the worm species belongs to the genus Eisenia.

61. The wastewater filtration system of any one of embodiments 54-60, wherein the worm species is Eisenia fetida or Eisenia andreii.

62. The wastewater filtration system of any one of embodiments 1-61, wherein the one or more plant species comprise a wetland or hydrophytic plant species.

63. The wastewater filtration system of any one of embodiments 1-61, wherein the one or more plant species is not Cyperus papyrus.

64. A filtration system for treating wastewater, the system comprising:
(a) a first inlet pipe configured to transfer greywater to the filtration system and a second inlet pipe configured to transfer blackwater to the filtration system;
(b) a first container fluidically connected to the first and second inlet pipes and configured to receive the greywater and the blackwater from the first and second inlet pipes, wherein the first container comprises a first vermifilter configured to treat the greywater and a second vermifilter configured to treat the blackwater, wherein the treated greywater and treated blackwater are combined in the first container to form a primary treated wastewater;
(c) a second container fluidically connected to the first container and configured to receive the primary treated wastewater from the first container, wherein the second container comprises a third vermifilter and one or more plant species configured to treat the primary treated wastewater to form a secondary treated wastewater; and
(d) an outlet pipe fluidically connected to the second container and configured to transfer the secondary treated wastewater out of the filtration system, wherein a portion of the first container is within the second container.

65. The filtration system of embodiment 64, wherein the first and second vermifilters comprise a biomedia and a worm species.

66. The filtration system of embodiment 64 or embodiment 65, wherein the first, second and third vermifilters comprise a biomedia, a worm species and a bacteria species.

67. The filtration system of any of embodiments 64-66, wherein the one or more plant species comprise a wetland or hydrophytic plant species.

68. A filtration system for treating wastewater, the system comprising:
(a) one or more inlet pipes configured to transfer wastewater to the filtration system;
(b) a container fluidically connected to the one or more inlet pipes and configured to receive the wastewater from the one or more inlet pipes, wherein the container comprises one or more vermifilters configured to treat the wastewater; and
(c) one or more outlet pipes fluidically connected to the container and configured to transfer the treated wastewater out of the filtration system.

69. The filtration system of embodiment 68, wherein the container comprises:
(i) a grate comprising the one or more vermifilters configured to treat the wastewater to form a primary treated wastewater, wherein the grate is fluidically connected to the one or more inlet pipes;
(ii) a sump tank configured to receive the primary treated wastewater; and
(iii) a pump configured to pump the primary treated wastewater to a filter system, wherein the filter system is configured to treat the primary treated wastewater to form a secondary treated wastewater,
wherein the one or more outlet pipes are configured to transfer the secondary treated wastewater out of the filtration system.

70. A filtration system for treating wastewater, the system comprising:
(a) one or more inlet pipes configured to transfer wastewater to the filtration system;
(b) a container fluidically connected to the one or more inlet pipes and configured to receive the wastewater from the one or more inlet pipes, wherein the container comprises:
(i) a grate comprising one or more vermifilters configured to treat the wastewater to form a primary treated wastewater;
(ii) a sump tank configured to receive the primary treated wastewater; and
(iii) a pump configured to pump the primary treated wastewater to a filter system, wherein the filter system is configured to treat the primary treated wastewater to form a secondary treated wastewater; and
(c) one or more outlet pipes fluidically connected to the container and configured to transfer the secondary treated wastewater out of the filtration system.

71. The filtration system of any one of embodiments 68-70, wherein the one or more inlet pipes transfer greywater and/or blackwater to the container.

72. The filtration system of any one of embodiments 68-71, wherein the filtration system comprises one inlet pipe.

73. The filtration system of any one of embodiments 68-72, wherein the filtration system comprises one outlet pipe.

74. The filtration system of any one of embodiments 68-73, wherein the grate is stair-step shaped and comprises two or more, three or more, four or more, five or more, or six or more stair-steps.

75. The filtration system of embodiment 74, wherein each stair-step of the stair-step shaped grate is permeable.

76. The filtration system of any one of embodiments 74-75, wherein the one or more vermifilters are located on each stair-step of the stair-step shaped grate.

77. The filtration system of any one of embodiments 68-76, wherein the one or more vermifilters comprise a biomedia, a bacteria species and/or a worm species.

78. The filtration system of any one of embodiments 68-77, wherein the one or more vermifilters comprises a biomedia, a bacteria species and a worm species.

79. The filtration system of any one of embodiments 68-78, wherein the filter system comprises a feed pipe, a water distribution system, and a filter tank.

80. The filtration system of embodiment 79, wherein the feed pipe is operably and/or fluidically connected to the pump, the water distribution system, and the filter tank.

81. The filtration system of embodiment 79 or embodiment 80, wherein the water distribution system comprises one or more sprinklers.

82. The filtration system of any one of embodiments 79-81, wherein the filter tank is permeable.

83. The filtration system of any one of embodiments 79-82, wherein the filter tank comprises a biomedia.

84. The filtration system of any one of embodiments 79-83, wherein the filter tank comprises a bacteria species and/or a worm species.

85. The filtration system of any one of embodiments 79-84, wherein the filter tank comprises a bacteria species.

86. The filtration system of any one of embodiments 79-85, wherein the filter tank comprises a bacteria species and a worm species.

87. The filtration system of any one of embodiments 77-86, wherein the biomedia provides a habitat for the worm species.

88. The filtration system of any one of embodiments 77-87, wherein the biomedia comprises rock, cinder (e.g., volcanic rock or lava rock), gravel, soil, coir, compost, wood chip, bark chip, plastic, or any combination thereof.

89. The filtration system of any one of embodiments 77-88, wherein the biomedia is coir.

90. The filtration system of any one of embodiments 77-89, wherein the biomedia is fine to coarse in size.

91. The filtration system of any one of embodiments 77-90, wherein the biomedia is medium to coarse in size.

92. The filtration system of any one of embodiments 77-91, wherein the worm species digests solid materials in the wastewater.

93. The filtration system of any one of embodiments 77-92, wherein the worm species belongs to the genus Eisenia.

94. The filtration system of any one of embodiments 77-93, wherein the worm species is Eisenia fetida or Eisenia andreii.

95. The filtration system of any one of embodiments 68-94, wherein:
(a) the wastewater flows from the one or more inlet pipes into the container to undergo one or more, two or more, three or more, four or more, five or more or six or more treatments; and
(b) the treated wastewater flows from the container into the one or more outlet pipes.

96. The filtration system of any one of embodiments 68-95, wherein the wastewater flows through the filtration system on a gravity gradient and/or a pressure gradient.

97. The filtration system of any one of embodiments 68-96, wherein the wastewater flows through the filtration system on a gravity gradient and a pressure gradient.

98. The filtration system of any one of embodiments 68-97, wherein:
the wastewater flows from the one or more inlet pipes into the container to the grate;
the wastewater flows from the grate to the sump tank via a gravity gradient, the wastewater undergoing a primary treatment;
the primary treated wastewater flows from the sump tank to the filter system via a pressure gradient, the primary treated wastewater undergoing a secondary treatment; and
the secondary treated wastewater flows from the filter tank to the sump tank via a gravity gradient, the secondary treated wastewater flowing from the sump tank to the one or more outlet pipes.

99. The filtration system of any one of embodiments 68-98, wherein:
the wastewater flows from the one or more inlet pipes into the container to the grate;
the wastewater flows from the grate to the sump tank via a gravity gradient, the wastewater undergoing a primary treatment;
the primary treated wastewater flows from the sump tank to the filter system via a pressure gradient, the primary treated wastewater undergoing a secondary treatment;
the secondary treated wastewater flows from the filter tank to the sump tank via a gravity gradient; and
the secondary treated wastewater flows from the sump tank to the filter system via the pump and feed pipe two or more, three or more, four or more, five or more or six or more times prior to flowing to the one or more outlet pipes.

100. The filtration system of any one of embodiments 68-99, wherein the filter system is a trickling filter system.

101. The filtration system of any one of claims 68-100, wherein the filter system is an aerated trickling filter system.

### EXAMPLES

The present disclosure will be more fully understood by reference to the following examples. They should not, however, be construed as limiting the scope of the invention. It is understood that the examples and embodiments described herein are for illustrative purposes only and that various modifications or changes in light thereof will be suggested to persons skilled in the art and are to be included within the spirit and purview of this application and scope of the appended claims.

### Example 1: Assessment of Organic Waste in Household Wastewater

During the process of developing the wastewater filtration system depicted in FIGS. 1-4, experiments were performed with the goal of optimizing the filtration system. Specifically, experiments were performed across 12 months to determine whether the wastewater filtration system reduced the presence of solid material (e.g., organic and/or inorganic material) in treated household wastewater. Organic and/or inorganic material was assessed by measuring biochemical oxygen demand (BOD) and total suspended solids (TSS) in the wastewater.

BOD is a key parameter for assessing water quality and measures the level of organic pollution in water by measuring how much oxygen is consumed by microorganisms breaking down the organic material. High levels of BOD (measured in mg/L) indicate high amounts of organic material. Methods of measuring BOD are known in the art. In the present example, the treated wastewater samples were collected and place in an airtight bottle for 5 days at 20° C. During this 5 day incubation, microorganisms in the water decompose organic material in the water. Prior to the 5 day incubation and after the 5 day incubation, dissolved oxygen (DO) was measured, and BOD was calculated with the following equation: BOD=(initial DO−final DO)×dilution factor/volume of sample.

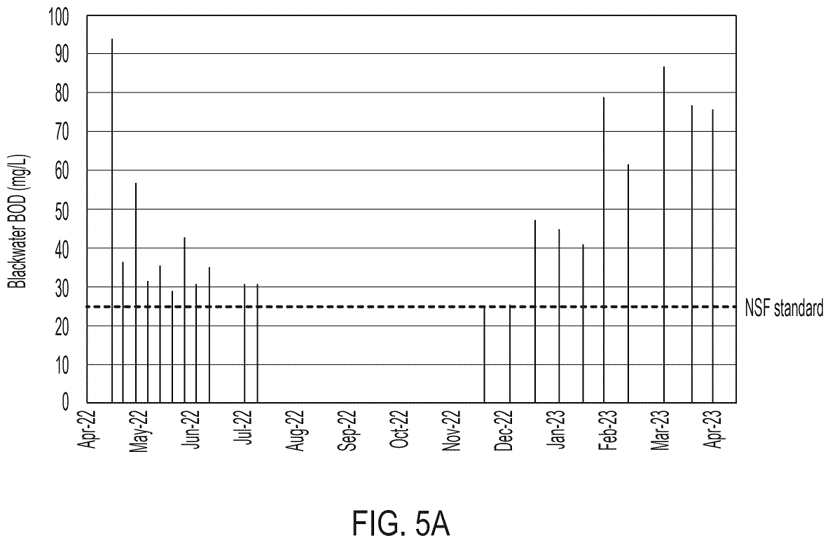

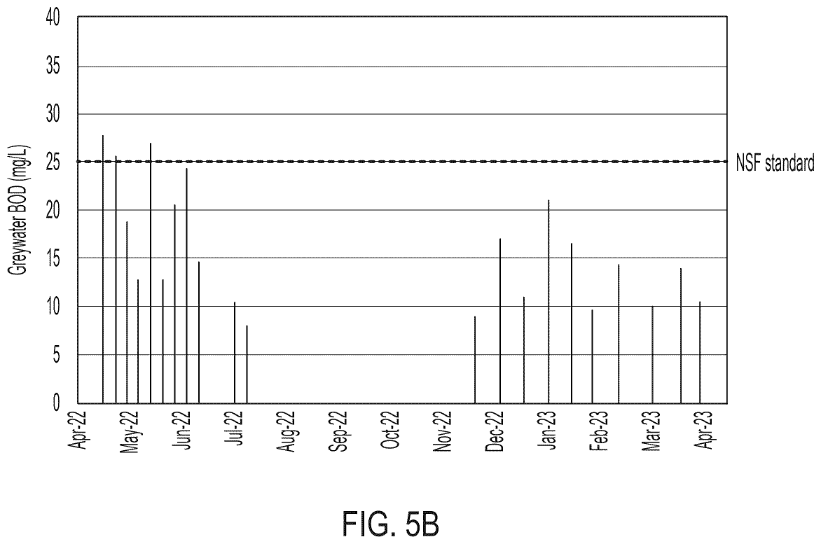

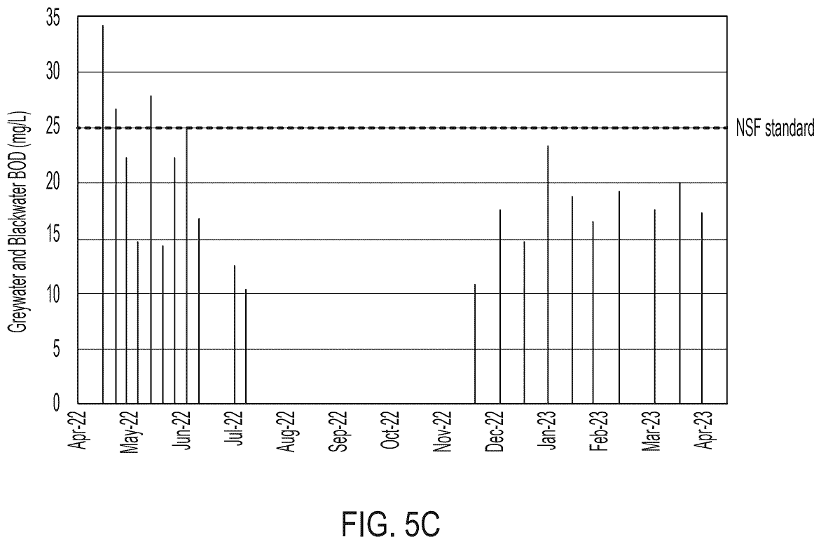

FIGS. 5A-5C depict BOD in blackwater (FIG. 5A), greywater (FIG. 5B) or both (FIG. 5C) across a 12 month period. However, BOD was not measured for the months of August to November. As shown in FIGS. 5B and 5C, average BOD was at or below the standard (25 mg/L) required by the National Sanitation Foundation (NSF) during most months of the year. The weighted average of BOD in the wastewater samples of FIGS. 5A-5C is depicted in Table 1 below.

TSS testing is a crucial parameter in assessing the quality of water, including wastewater, as it measures the amount of solid organic and inorganic particles suspended in wastewater. In the wastewater filtration system provided herein, the worm species of the vermifilter digests solid wastes in the wastewater and any undigested solid materials are captured and retained in the bottom chamber of the first container (also known as the sedimentation basin), such that the treated wastewater that flows out of the filtration system has reduced levels of solids.

Methods of measuring TSS are known in the art. The most widely used method for measuring TSS includes gravimetric analysis, which involves weighing solid particles collected on a glass-fiber or cellulose ester membrane filter. In this example, a filtering apparatus was assembled and suction was initiated. The filter was wetted with a small volume of distilled water to ensure proper fitting against its support. The treated wastewater sample was vigorously shaken and added to the filter in a predetermined volume while the vacuum was continuously applied to the filter. The vacuum step allowed for the removal of all water from the sample and only solid particle residue remained on the filter. The filter was then washed three times with distilled water and allowed to dry completely between each wash. The filter was then detached from its support and dried for at least one hour at 103° C.-105° C. The filter was cooled in a desiccator and weighed. TSS was then calculated with the following equation: (C−D)×1000/V, wherein C=weight of filter+solid particles, D=weight of filter without solid particles, and V=volume (L) of the wastewater sample that was filtered.

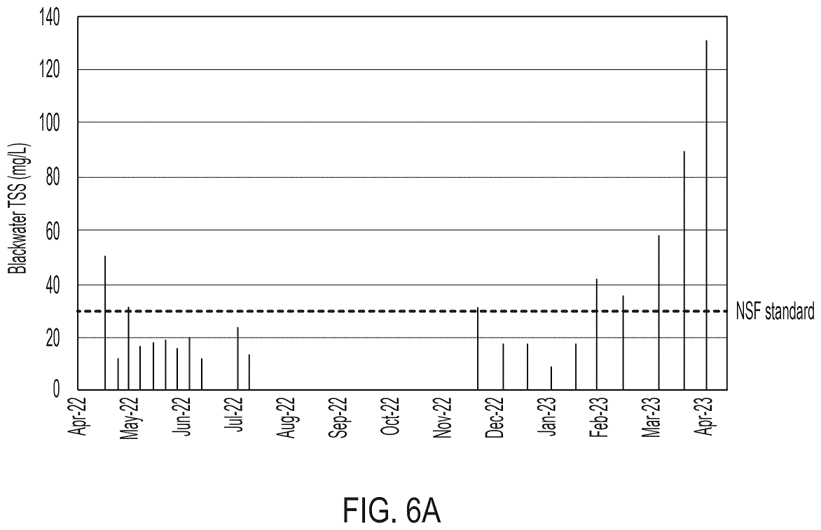

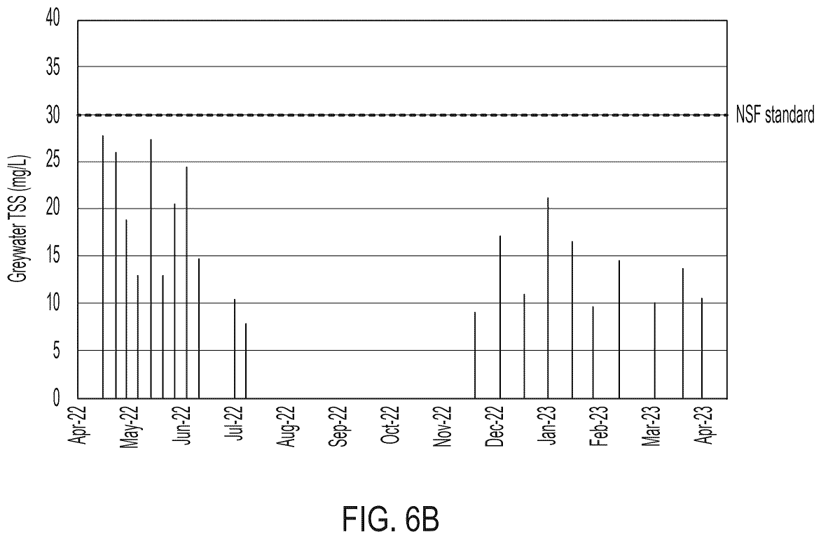

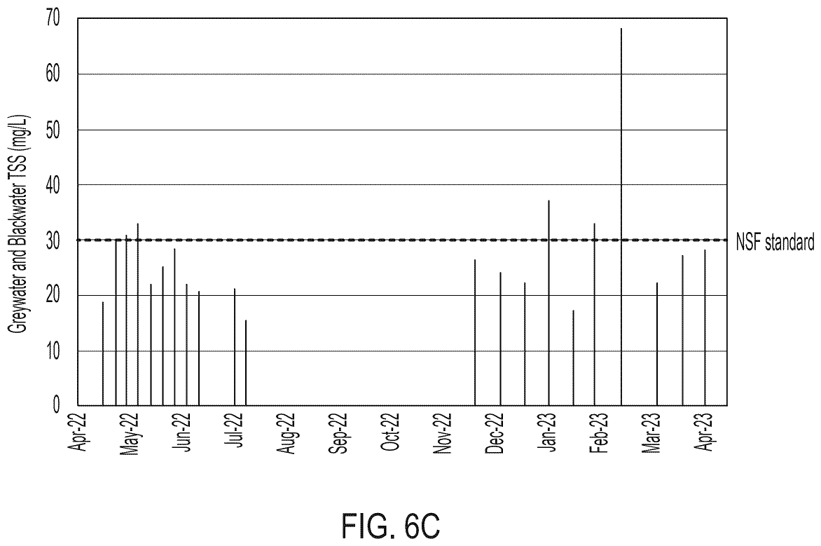

FIGS. 6A-6C depict TSS in blackwater (FIG. 6A), greywater (FIG. 6B) or both (FIG. 6C) across a 12 month period. However, TSS was not measured for the months of August to November. As shown in FIGS. 6A-6C, average TSS was at or below the standard (30 mg/L) required by the NSF during most months of the year. The weighted average of TSS in the wastewater samples of FIGS. 6A-6C is depicted in Table 1.

TABLE 1
Average BOD and TSS (mg/L) across 12 months

| | Treated | Treated | Treated Blackwater (10%) |
|---|---|---|---|
| | Blackwater | Greywater | and Greywater (90%) |
| BOD (mg/L) | 47.2 | 16.7 | 19.8 |
| TSS (mg/L) | 33.2 | 26.1 | 26.8 |

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

The present invention is not intended to be limited in scope to the particular disclosed embodiments, which are provided, for example, to illustrate various aspects of the invention. Various modifications to the device and methods described will become apparent from the description and teachings herein. Such variations may be practiced without departing from the true scope and spirit of the disclosure and are intended to fall within the scope of the present disclosure.

1. A filtration system for treating wastewater, the system comprising:
(a) one or more inlet pipes configured to transfer wastewater to the filtration system;
(b) a first container fluidically connected to the one or more inlet pipes and configured to receive the wastewater from the one or more inlet pipes, wherein the first container comprises one or more first vermifilters configured to treat the wastewater to form a primary treated wastewater;
(c) a second container fluidically connected to the first container and configured to receive the primary treated wastewater from the first container, wherein the second container comprises one or more second vermifilters and one or more plant species and the one or more second vermifilters and/or one or more plant species are configured to treat the primary treated wastewater to form a secondary treated wastewater; and
(d) one or more outlet pipes fluidically connected to the second container and configured to transfer the secondary treated wastewater out of the filtration system,
wherein a portion of the first container is within the second container.

2. The wastewater filtration system of claim 1, wherein the wastewater flows through the wastewater filtration system on a gravity gradient.

3. The wastewater filtration system of claim 1, wherein the wastewater flows into the first container to undergo a primary treatment and the primary treated wastewater flows into the second container to undergo a secondary treatment.

4. The wastewater filtration system of claim 3, wherein:
(a) the wastewater flows from the one or more inlet pipes into the first container to undergo the primary treatment;
(b) the primary treated wastewater flows from the first container into the second container to undergo the secondary treatment; and
(c) the secondary treated wastewater flows from the second container into the one or more outlet pipes.

5. The wastewater filtration system of claim 3, wherein the primary and secondary treatment reduce the amount of solid material or suspended solids in the wastewater.

6. The wastewater filtration system of claim 1, wherein the one or more inlet pipes transfer wastewater from a wastewater source to the first container.

7. The wastewater filtration system of claim 1, wherein the wastewater filtration system comprises one inlet pipe or two inlet pipes.

8. The wastewater filtration system of claim 1, wherein the one or more outlet pipes collects secondary treated wastewater and transfers it to a disposal site.

9. The wastewater filtration system of claim 1, wherein the one or more outlet pipes comprises one or more pipes operably and/or fluidically connected with a pipe tee fitting.

10. The wastewater filtration system of claim 1, wherein the one or more outlet pipes comprises a first, second and third pipe operably and/or fluidically connected with a pipe tee fitting.

11. The wastewater filtration system of claim 10, wherein the first and second pipes are perforated to collect the treated wastewater.

12. The wastewater filtration system of claim 10, wherein the first and second pipes transfer the secondary treated wastewater to the third pipe.

13. The wastewater filtration system of claim 1, wherein the first container is a multi-chamber container.

14. The wastewater filtration system of claim 1, wherein the first container comprises a top chamber and a bottom chamber.

15. The wastewater filtration system of claim 14, wherein the top chamber is separated from the bottom chamber by a grate.

16. The wastewater filtration system of claim 15, wherein the grate is porous.

17. The wastewater filtration system of claim 14, wherein the bottom chamber is a sedimentation basin.

18. The wastewater filtration system of claim 14, wherein the bottom chamber comprises one or more holes to allow the primary treated wastewater to flow into the second container.

19. The wastewater filtration system of claim 14, wherein the top chamber is subdivided into a first chamber and a second chamber.

20. A filtration system for treating wastewater, the system comprising:
(a) a first inlet pipe configured to transfer greywater to the filtration system and a second inlet pipe configured to transfer blackwater to the filtration system;
(b) a first container fluidically connected to the first and second inlet pipes and configured to receive the greywater and the blackwater from the first and second inlet pipes, wherein the first container comprises a first vermifilter configured to treat the greywater and a second vermifilter configured to treat the blackwater, wherein the treated greywater and treated blackwater are combined in the first container to form a primary treated wastewater;
(c) a second container fluidically connected to the first container and configured to receive the primary treated wastewater from the first container, wherein the second container comprises a third vermifilter and one or more plant species configured to treat the primary treated wastewater to form a secondary treated wastewater; and
(d) an outlet pipe fluidically connected to the second container and configured to transfer the secondary treated wastewater out of the filtration system,
wherein a portion of the first container is within the second container.

21. A filtration system for treating wastewater, the system comprising:
(a) one or more inlet pipes configured to transfer wastewater to the filtration system;
(b) a container fluidically connected to the one or more inlet pipes and configured to receive the wastewater from the one or more inlet pipes, wherein the container comprises one or more vermifilters configured to treat the wastewater; and
(c) one or more outlet pipes fluidically connected to the container and configured to transfer the treated wastewater out of the filtration system.

22. The filtration system of claim 21, wherein the container comprises:
(i) a grate comprising the one or more vermifilters configured to treat the wastewater to form a primary treated wastewater, wherein the grate is fluidically connected to the one or more inlet pipes;
(ii) a sump tank configured to receive the primary treated wastewater; and
(iii) a pump configured to pump the primary treated wastewater to a filter system, wherein the filter system is configured to treat the primary treated wastewater to form a secondary treated wastewater,
wherein the one or more outlet pipes are configured to transfer the secondary treated wastewater out of the filtration system.

23. A filtration system for treating wastewater, the system comprising:
(a) one or more inlet pipes configured to transfer wastewater to the filtration system;
(b) a container fluidically connected to the one or more inlet pipes and configured to receive the wastewater from the one or more inlet pipes, wherein the container comprises:
(i) a grate comprising one or more vermifilters configured to treat the wastewater to form a primary treated wastewater;
(ii) a sump tank configured to receive the primary treated wastewater; and
(iii) a pump configured to pump the primary treated wastewater to a filter system, wherein the filter system is configured to treat the primary treated wastewater to form a secondary treated wastewater; and
(c) one or more outlet pipes fluidically connected to the container and configured to transfer the secondary treated wastewater out of the filtration system.

24. The filtration system of claim 21, wherein the filtration system comprises one inlet pipe and one outlet pipe.

25. The filtration system of claim 21, wherein the grate is stair-step shaped and comprises two or more, three or more, four or more, five or more, or six or more stair-steps.

26. The filtration system of claim 25, wherein each stair-step of the stair-step shaped grate is permeable.

27. The filtration system of claim 21, wherein the filter system comprises a feed pipe, a water distribution system, and a filter tank.

28. The filtration system of claim 27, wherein the filter tank is permeable.

29. The filtration system of claim 21, wherein:
the wastewater flows from the one or more inlet pipes into the container to the grate;
the wastewater flows from the grate to the sump tank via a gravity gradient, the wastewater undergoing a primary treatment;
the primary treated wastewater flows from the sump tank to the filter system via a pressure gradient, the primary treated wastewater undergoing a secondary treatment; and
the secondary treated wastewater flows from the filter tank to the sump tank via a gravity gradient, the secondary treated wastewater flowing from the sump tank to the one or more outlet pipes.

30. The filtration system of claim 21, wherein:
the wastewater flows from the one or more inlet pipes into the container to the grate;
the wastewater flows from the grate to the sump tank via a gravity gradient, the wastewater undergoing a primary treatment;
the primary treated wastewater flows from the sump tank to the filter system via a pressure gradient, the primary treated wastewater undergoing a secondary treatment;
the secondary treated wastewater flows from the filter tank to the sump tank via a gravity gradient; and
the secondary treated wastewater flows from the sump tank to the filter system via the pump and feed pipe two or more, three or more, four or more, five or more or six or more times prior to flowing to the one or more outlet pipes.
